(19) United States
(12) Patent Application Publication
(10) Pub. No.: US 2024/0289407 A1
(43) Pub. Date: Aug. 29, 2024

(54) SEARCH WITH STATEFUL CHAT

(71) Applicant: GOOGLE LLC, Mountain View, CA (US)

(72) Inventors: Mahsan Rofouei, Menlo Park, CA (US); Anand Shukla, Palo Alto, CA (US); Qing Wei, Mountain View, CA (US); Chi Tang, Mountain View, CA (US); Ryan Brown, San Diego, CA (US); Enrique Piqueras, San Jose, CA (US)

(21) Appl. No.: 18/589,371

(22) Filed: Feb. 27, 2024

Related U.S. Application Data
(60) Provisional application No. 63/448,923, filed on Feb. 28, 2023.

(51) Int. Cl. G06F 16/957; G06F 16/9532; G06F 16/9535; G06F 40/40

(52) U.S. Cl. CPC G06F 16/9577; G06F 16/9532; G06F 16/9535; G06F 40/40

(57) ABSTRACT

Implementations are described herein for augmenting a traditional search session with stateful chat—via what will be referred to as a “generative companion”—to facilitate more interactive searching. In various implementations, a query may be received, e.g., from a client device operated by a user. Contextual information associated with the user or the client device may be retrieved. Generative model (GM) output may be generated based on processing, using a generative model, data indicative of the query and the contextual information. Synthetic queries may be generated using the GM output, and search result documents (SRDs) may be selected. State data indicative of: the query, contextual information, one or more of the synthetic queries, and the set of search result documents, may be processed to identify a classification of the query. Based on the classification downstream GM(s) may be selected and used to generate one or more additional GM outputs.

Individuals frequently use search engines to search for information about various topics. In many cases, a single search session about multiple related topics (e.g., planning a vacation) may involve an individual issuing multiple different search queries to obtain multiple different responsive search result pages. Sometimes subsequent queries may be composed to narrow down search results from previous queries. Other subsequent queries may be composed to identify search results that are different from those returned in response to prior queries, but that fall under a larger umbrella of topics. For example, when planning a vacation, an individual may first search for a flight, then a hotel, then for dinner reservations, and so forth. The longer a search session, the more likely the individual is to become overwhelmed with too much information and/or to lose track of information that was surfaced during prior turns.

### SUMMARY

Implementations are described herein for augmenting a traditional search session with stateful chat—via what will be referred to as a “generative companion”—to facilitate more interactive searching. More particularly, but not exclusively, implementations are described herein for maintaining and updating a contextual state of a user across multiple turns of a chat search session, and using that user's state at each turn to provide content that is not only directly responsive to the latest query issued by the user, but is tailored to the user's ongoing state. Processing more than just the user's query can, for example, mitigate occurrences of responsive natural language (NL) based content including inaccuracies and/or hallucinations, and/or can mitigate occurrences of the response NL based content being over-specified and/or under-specified. This also enables effective guiding of a human-to-computer dialog/session in which the query was submitted, and ensures that the responsive NL based content resonates with the user that submitted the query.

In various implementations, a query may be received from a user, e.g., from a client device operated by the user. The query may take various forms. In some implementations, the query may be a textual query that is typed or generated from the user's utterance using speech recognition processing. In some implementations, the query may include natural language typed or spoken by the user. In some implementations, the query may be multimodal. For example, in addition to or instead of natural language, the query may include other modalities of data, such as images, sounds, gesture input, documents, and so forth.

In various implementations, the user's state may be ascertained, e.g., by retrieving contextual information associated with the user or the client device. Some examples of contextual signals that may be generated by a client device include, for instance, time of day, location, current activity (e.g., determined from an accelerometer and/or gyroscope), foregrounded and/or backgrounded applications, and so forth. Other contextual information that may be relative to the present disclosure include the user's schedule. For example, electronic correspondence, electronic calendars, etc., may be consulted to determine where a user is, is supposed to be, or will be at a particular time.

Yet other contextual information that may be relevant to the present disclosure includes contextual information related to the current and/or prior search sessions conducted by the user and/or by others. For example, prior queries input by the user during the same session and/or during previous search sessions may be retrieved and encoded into the user's state. Additionally or alternatively, content responsive to prior queries, e.g., that was presented to the user during previous turn(s) of the search session, may also be encoded into the user's state. For example, prior search result pages (SRPs), including the hyperlinks and accompanying passages of text, may be encoded into the user's state.

The user's state may take various forms. In some implementations, the user's state may be persisted in memory as one or more semantically-rich embeddings. For example, each prior query, or even each word of each prior query, may be tokenized into distinct embeddings. These embeddings may be aggregated, e.g., with other embeddings indicative of other contextual information, into an aggregate embedding that represents the user's state as a whole.

In various implementations, various types of generative models may be used to process various data to facilitate stateful search and/or the generative companion as described herein. In some implementations, a first large language model (LLM) may be used to process data indicative of the user's state, such as the query and/or contextual information, to generate LLM output. The LLM output generated by the first LLM may take the form of, for instance, a sequence of predicted tokens. These tokens may represent, for instance, words, phrases, or the entireties of one or more additional or alternative queries. These additional/alternative queries may be, for instance, alternative query suggestions, supplemental queries, rewritten versions of the user's query, and/or “drill down” queries that are generated using the first LLM, and that are meant to direct the user's search to responsive content that has increased value to the user relative to what would have been returned based solely on the user's query.

While many examples described herein refer to LLMs, this is not meant to be limiting. Various forms of generative models may be used to carry out selected aspects of the present disclosure and/or may be configured to process various modalities of data. Some non-limiting examples of generative models may include, for instance, LLMs, PaLM, BERT, LaMDA, Meena, vision-language models (VLMs), image diffusion models, and/or any other generative model that is encoder-only based, decoder-only based, sequence-to-sequence based and that optionally includes an attention mechanism or other memory.

In various implementations, a plurality of query-responsive search result documents that are responsive to both the query and the one or more additional queries may be selected for inclusion in a set of search result documents. For example, the user's query and the additional queries may be executed, e.g., by being submitted to a search engine. The results returned by the search engine may include the set of search result documents.

In various implementations, user's state data, which at this point may be indicative of the user's query, the retrieved contextual information, one or more of the additional queries, and the set of search result documents, may be processed, e.g., using one or more machine learning models, to identify a classification of the query. The classification may be one of several candidate classifications. Non-limiting examples of candidate classifications may include, for example, (i) “needs creative text generation,” (ii) “needs creative media generation,” (iii) “can benefit from ambient generative summarization,” (iv) “can benefit from SRP summarization,” (v) “would benefit from suggested next step query,” (vi) “needs clarification,” (vii) “do not interfere,” and so forth.

Based on the classification of the query, one or more downstream LLMs may be selected for additional processing. These downstream LLMs may include LLMs that are trained to generate different types of LLM outputs that are targeted towards the candidate classifications described previously. For example, one or more downstream LLMs may be creative LLM(s) that are usable to process various types of input (e.g., a user's state and query) to generate LLM output(s) in the form of creative text, creative imagery, creative sounds and/or music, etc. The type of creative LLM applied and/or the type of creative content generated by a creative LLM may be largely dictated by the user's query. For instance, the user could request composition of a poem, rendition of an image, short story, satirical article, etc.

Another downstream LLM may include an ambient generative summarization LLM. An ambient generative summarization LLM may be trained to generate a summary of one or more specific documents. For example, if a user clicks a link on a SRP to access a linked-to document, the content of that document may be summarized for the user (e.g., upon the user's request).

Another downstream LLM may include an SRP summarization LLM. A SRP summarization LLM may be trained to summarize SRPs, including passages of text that are rendered in proximity to the links, context extracted from the linked-to documents, titles of the documents, other metadata associated with the documents, and so forth. In some implementations, the SRP summarization LLM may be trained to generate multimodal output, such as a summary of multiple search results accompanied by images pulled from one or more of the search results that can be used as illustrations that accompany the SRP summary.

Yet other downstream LLMs may include, for instance, next step LLMs (or other machine learning models) trained to generate suggested next step queries. These next step LLMs may be similar to the LLM used to generate the additional queries, in some implementations. If the user selects a suggested next query, that selected next query may be used as the current query during the next iteration of the current search session. In some implementations, the suggested next query may include suggestions for drilling down the user's search results. For example, if there are more than one thousand results on the SRP but the results can be broadly grouped into three categories, the suggested next step queries may offer the user three categorical options. In some implementations, additional media may be recommended based on the suggested next step queries. For example, digital content items for products that are highly responsive to a suggested next step query may be selected and presented.

Yet other downstream LLMs may include, for instance, clarification LLMs (or other machine learning models) trained to generate natural language seeking clarification from the user about what the user is seeking. For example, if there are ambiguous term(s) in the user's current query that cannot be resolved using the user's state, one or more prompts may be generated, e.g., using a clarification LLM, that seek clarification from the user. In some cases, if multiple conflicting interpretations are identified, these may be presented to the user as choices from which the user can select. Suppose the user simply states, “New York.” Summarizing the SRP generated from such a vague search would not likely be helpful. Accordingly, the clarification LLM may generate a question such as, “what about New York?” Additionally or alternatively, and based on the user's state, a clarification LLM may generate questions about the user's general state of mind and/or current activity to enrich the user's state further.

In various implementations, one or more of these downstream LLMs may be selected. One or more additional LLM outputs may then be generated based on processing, using the selected one or more downstream LLMs, at least some of the state data. NL content responsive to the user's original query, which may be augmented or otherwise may include content generated by one or more of the downstream LLMs, may to be rendered at the client device.

In these and other manners, the responsive NL content guides the human-to-computer dialog/search session by being updated to reflect interaction(s) with content such as search result document(s) and/or search result pages that occurred thus far in the interaction. Accordingly, through the responsive NL based content, the user is guided to additional information that facilitates the user accomplishing their task, where the additional information accounts for the interaction(s) with content that has already occurred during the human-to-computer interaction.

NL is not the only kind of output that might be returned during a given iteration of the user's search session. In some cases, an updated SRP may be presented, similar to conventional internet searching. However, the updated SRP may be generated in response to not only the user's current query, but also based on the user's state, additional queries, etc. Consequently, the updated SRP may be tailored not only to the user's most recent query, but to a general trajectory of the user's entire search session. Additionally or alternatively, if the creative LLM generates media such as imagery and/or sound, that media may be presented to the user as output during the turn.

In some implementations, a method may be implemented by one or more processors during a search session of a user and may include: receiving a query associated with a client device operated by the user; retrieving contextual information associated with the user or the client device; generating large language model (LLM) output based on processing, using an LLM, data indicative of the query and the contextual information; generating one or more synthetic queries using the LLM output; selecting a set of search result documents, selecting the set of search result documents including selecting, for inclusion in the set, a plurality of query-responsive search result documents based on the query-responsive search result documents being responsive to the query and the one or more synthetic queries; processing state data indicative of the query, contextual information, one or more of the synthetic queries, and the set of search result documents to identify a classification of the query; based on the classification of the query, selecting one or more downstream LLMs; generating one or more additional LLM outputs based on processing, using the selected one or more downstream LLMs, at least some of the state data; and causing natural language (NL) responsive to the query to be rendered at the client device.

In various implementations, the contextual information associated with the user or the client device may include: one or more prior queries issued by the user during the search session; data extracted from one or more search results pages returned in response to one or more prior queries issued by the user during the search session; data extracted from one or more prior-query-responsive search result documents returned in response to one or more prior queries issued by the user during the search session; information about a schedule of the user; and/or position coordinates of the user.

In various implementations, the state data may include an aggregate embedding generated from the query, contextual information, one or more of the synthetic queries, and the set of search result documents. In various implementations, the state data may include data extracted from one or more search results pages returned in response to one or more of the synthetic queries. In various implementations, the state data may include data indicative of one or more actions performed by the user subsequent to issuing the query. In various implementations, the data indicative of one or more actions may include data extracted from one or more of the query-responsive search result documents accessed by the user.

In various implementations, one or more of the downstream LLMs may include: a creative LLM trained to generate creative natural language (NL); an ambient LLM trained to generate a summary of a document accessed by the user subsequent to issuing the query; or a search results LLM trained to generate summaries of search results pages.

In various implementations, the NL responsive to the query may be included in subsequent contextual information retrieved during one or more subsequent turns of the search session of the user. In various implementations, the contextual information may include prior NL responsive to a prior query issued by the user during the search session.

In some implementations, a method may be implemented using one or more processors and may include: receiving a query associated with a client device operated by the user; retrieving contextual information associated with the user or the client device; generating generative model (GM) output based on processing, using an GM, data indicative of the query and the contextual information; generating one or more synthetic queries using the GM output; selecting a set of search result documents, selecting the set of search result documents including selecting, for inclusion in the set, a plurality of query-responsive search result documents based on the query-responsive search result documents being responsive to the query and the one or more synthetic queries; processing state data indicative of the query, contextual information, one or more of the synthetic queries, and the set of search result documents to identify a classification of the query; based on the classification of the query, selecting one or more downstream GMs; generating one or more additional GM outputs based on processing, using the selected one or more downstream GMs, at least some of the state data; and causing content responsive to the query to be rendered at the client device.

In addition, some implementations include one or more processors of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts a flowchart illustrating an example method of generating, using a large language model (LLM) and search result documents that are responsive to a query, a natural language (NL) based summary response to the query, and causing the NL based summary to be rendered in response to the query.

FIG. 3 depicts a flowchart illustrating an example method of selectively linkifying portion(s) of NL based content (e.g., an NL based summary) with link(s) to document(s) that verify the portion(s).

FIG. 4 depicts a flowchart illustrating an example method of generating, using an LLM, a revised NL based summary response to a query, where the revised NL based summary response is generated in response to user interaction with search result document(s) that are responsive to the query.

FIG. 5 depicts a flowchart illustrating an example method of selecting none, one, or multiple generative model(s) to utilize in generating response(s) to render responsive to a query, and using the selected generative model(s), if any, in generating response(s) to the query.

FIG. 6 depicts a flowchart illustrating an example method of generating, using an LLM, an NL based summary in dependence on whether a submitter of the query is already familiar with certain content that is responsive to the query.

FIG. 7A depicts an example client device rendering a graphical interface that includes an example NL based summary and additional example search results that are rendered in response to a query.

FIG. 7B depicts the example client device and graphical interface of FIG. 7A, after a user has interacted with an interface element to view search results for search result document sources utilized in generating the example NL based summary of FIG. 7A.

FIG. 8 schematically depicts an example of how a generative companion may be implemented to enhance a search session, in accordance with various implementations.

FIG. 9 depicts a flowchart illustrating an example method of implementing a generative companion.

FIG. 10 depicts an example architecture of a computing device, in accordance with various implementations.

### DETAILED DESCRIPTION

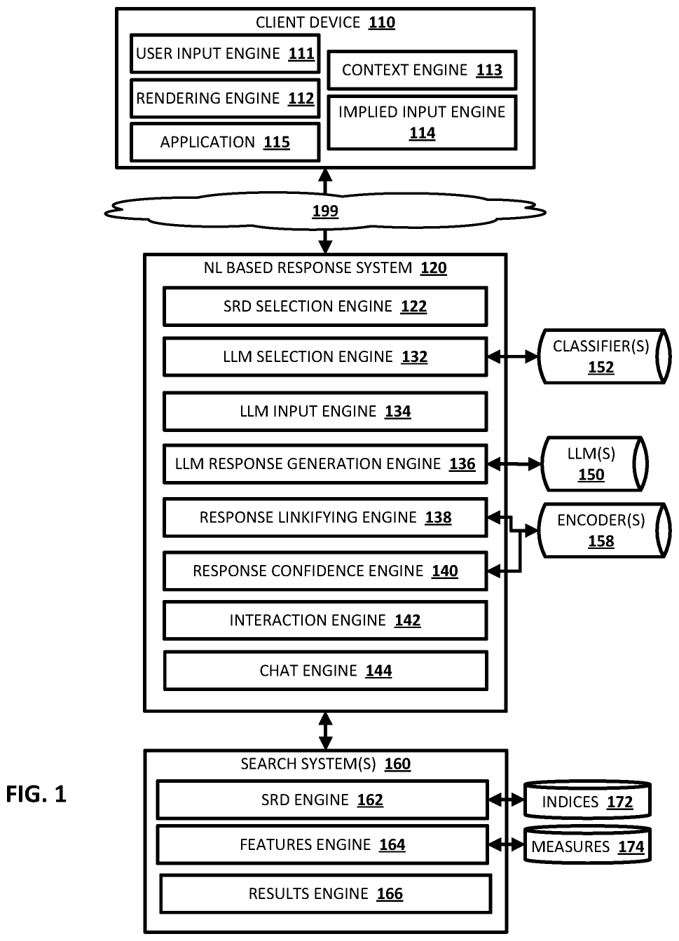

Turning now to FIG. 1, a block diagram of an example environment 100 that demonstrates various aspects of the present disclosure, and in which implementations disclosed herein can be implemented is depicted. The example environment 100 includes a client device 110, a natural language (NL) based response system 120, and search system(s) 160. Although illustrated separately, in some implementations all or aspects of NL based response system 120 and all or aspects of search system(s) 160 can be implemented as part of a cohesive system.

In some implementations, all or aspects of the NL based response system 120 can be implemented locally at the client device 110. In additional or alternative implementations, all or aspects of the NL based response system 120 can be implemented remotely from the client device 110 as depicted in FIG. 1 (e.g., at remote server(s)). In those implementations, the client device 110 and the NL based response system 120 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more applications, such as application 115, via which queries can be submitted and/or NL based summaries and/or other response(s) to the query can be rendered (e.g., audibly and/or visually). The application 115 can be an application that is separate from an operating system of the client device 110 (e.g., one installed “on top” of the operating system)—or can alternatively be implemented directly by the operating system of the client device 110. For example, the application 115 can be a web browser installed on top of the operating system, or can be an application that is integrated as part of the operating system functionality. The application 115 can interact with the NL based response system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110. Some instances of a query described herein can be a query that is formulated based on user input provided by a user of the client device 110 and detected via user input engine 111. For example, the query can be a typed query that is typed via a physical or virtual keyboard, a suggested query that is selected via a touch screen or a mouse, a spoken voice query that is detected via microphone(s) of the client device, or an image query that is based on image(s) captured by a vision component of the client device.

In various implementations, the client device 110 can include a rendering engine 112 that is configured to provide content (e.g., an NL based summary, creative LLM output, chat output, etc.) for audible and/or visual presentation to a user of the client device 110 using one or more user interface output devices. For example, the client device 110 can be equipped with one or more speakers that enable content to be provided for audible presentation to the user via the client device 110. Additionally, or alternatively, the client device 110 can be equipped with a display or projector that enables content to be provided for visual presentation to the user via the client device 110.

In various implementations, the client device 110 can include a context engine 113 that is configured to determine a context (e.g., current or recent context) of the client device 110 and/or of a user of the client device 110. In a multi-turn search session implemented in accordance with selected aspects of the present disclosure, the context of the client device and/or user may be maintained over multiple turns as a “user state.”

In some implementations, the context engine 113 can determine a context and/or update the user's state utilizing current or recent interaction(s) via the client device 110, a location of the client device 110, profile data of a profile of a user of the client device 110 (e.g., an active user when multiple profiles are associated with the client device 110), and/or other data accessible to the context engine 113. For example, the context engine 113 can determine a current context based on a one or more recent queries of the search session, profile data, and/or a current location of the client device 110. For instance, the context engine 113 can determine a current context of “looking for a healthy lunch restaurant in Louisville, Kentucky” based on a recently issued query, profile data, and a location of the client device 110.

As another example, the context engine 113 can determine a current context based on which application is active in the foreground of the client device 110, a current or recent state of the active application, and/or content currently or recently rendered by the active application. A context determined by the context engine 113 can be utilized, for example, in supplementing or rewriting a query that is formulated based on user input, in generating an implied query (e.g., a query formulated independent of user input), and/or in determining to submit an implied query and/or to render result(s) (e.g., an NL based summary) for an implied query. And the user's context across multiple turns of a search session can be used as the aforementioned user state to enrich output rendered, e.g., by a search chatbot companion, at each turn of the search session.

In various implementations, the client device 110 can include an implied input engine 114 that is configured to: generate an implied query independent of any user input directed to formulating the implied query; to submit an implied query, optionally independent of any user input that requests submission of the implied query; and/or to cause rendering of result(s) for an implied query, optionally independent of any user input that requests rendering of the result(s)). For example, the implied input engine 114 can use current context, from current context engine 113, in generating an implied query, determining to submit the implied query, and/or in determining to cause rendering of result(s) for the implied query. For instance, the implied input engine 114 can automatically generate and automatically submit an implied query based on the current context. Further, the implied input engine 114 can automatically push result(s) to the implied query to cause them to be automatically rendered or can automatically push a notification of the result(s), such as a selectable notification that, when selected, causes rendering of the result(s). As another example, the implied input engine 114 can generate an implied query based on profile data (e.g., an implied query related to an interest of a user), submit the query at regular or non-regular intervals, and cause corresponding result(s) for the submission(s) to be automatically provided (or a notification thereof automatically provided). For instance, the implied query can be “patent news” based on profile data indicating interest in patents, the implied query periodically submitted, and a corresponding NL based summary result automatically rendered. It is noted that the provided NL based summary result can vary over time in view of e.g., presence of new/fresh search result document(s) over time.

Further, the client device 110 and/or the NL based response system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form a coordinated ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household).

NL based response system 120 is illustrated as including a search result document (SRD) selection engine 122, an LLM selection engine 132, an LLM input engine 134, an LLM response generation engine 136, a response linkifying engine 138, a response confidence engine 140, an interaction engine 142, and a chat engine 144. Some of the engines can be omitted in various implementations.

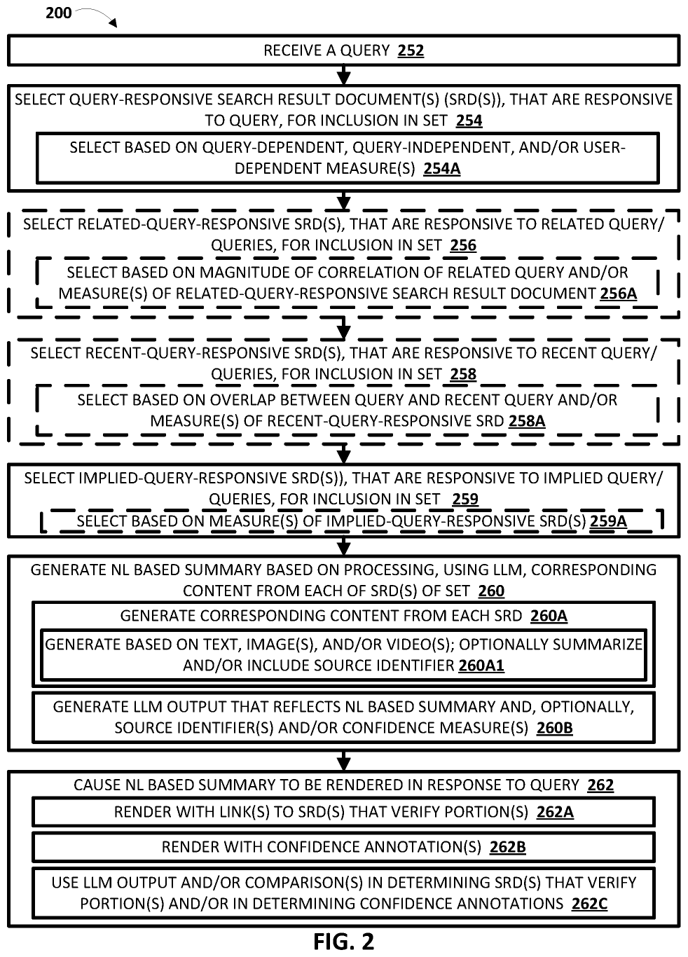

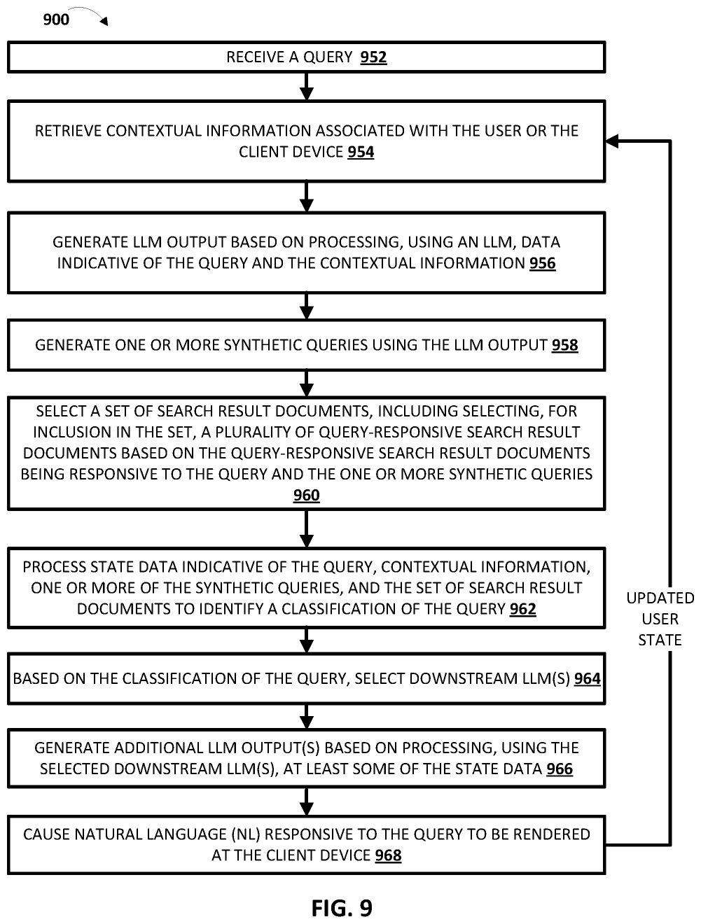

In some implementations, SRD selection engine 122 may be configured to perform all or aspects of blocks 254, 256, 258, and 259 of method 200 of FIG. 2, and/or aspect(s) of block 960 of FIG. 9.

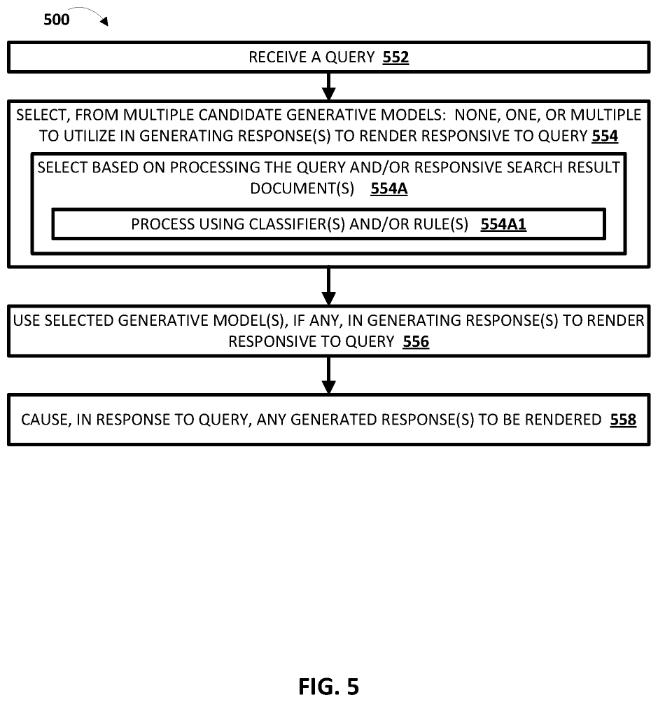

The LLM selection engine 132 can, for example, select zero or more generative models from multiple candidate LLMS. For example, in some iterations the system will determine to not utilize any of the candidate generative models, in some iterations the system will determine to utilize only one of the candidate generative models, and in some iterations the system will determine to utilize multiple of the candidate generative models. In some implementations, LLM selection engine 132 may be configured to perform all or aspects of block 554 of method 500 of FIG. 5, and/or aspect(s) of blocks 962-964 of FIG. 9. LLM selection engine 132 can optionally utilize one or more classifiers 152 and/or rules (not illustrated).

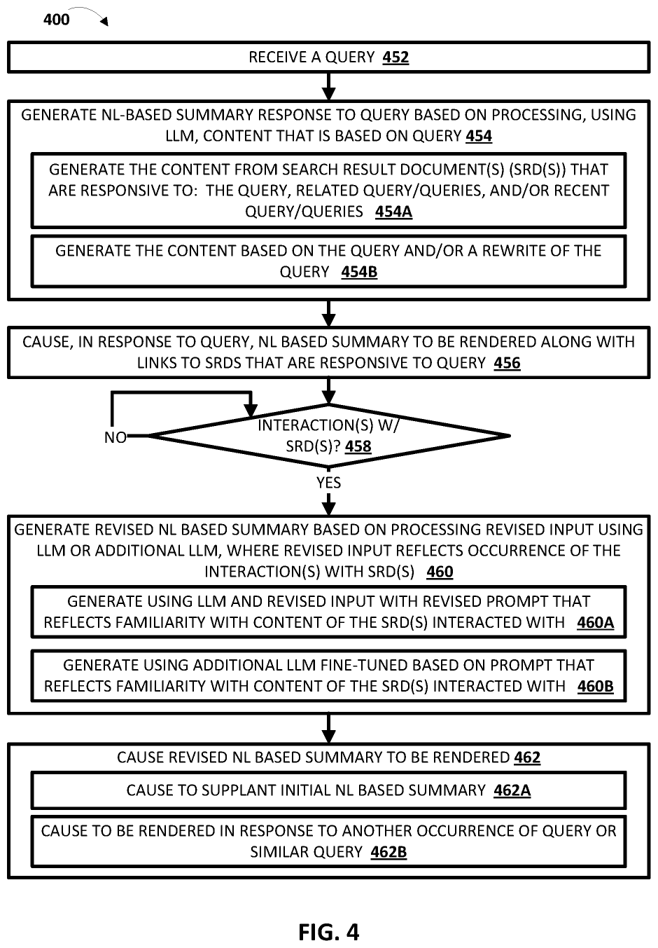

The LLM input engine 134 can, for example, perform all or aspects of sub-block 260A of method 200 of FIG. 2, aspects of blocks 454 and 460 of method 400 of FIG. 4, aspects of blocks 962 and/or 966-968 of FIG. 9, etc.

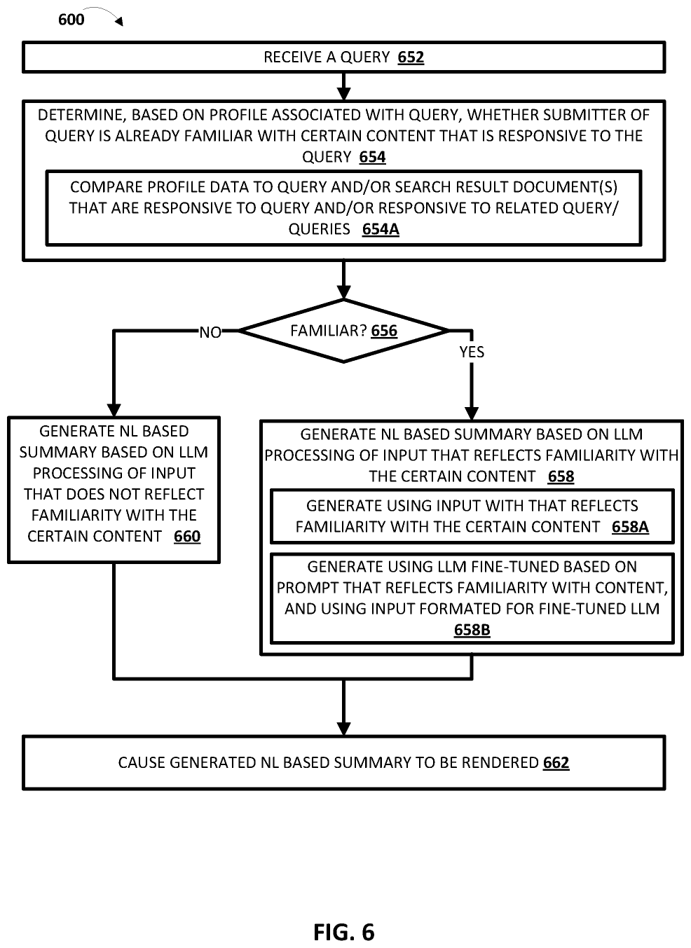

The LLM response generation engine 136 can, for example, perform all or aspects of block 260 of method 200 of FIG. 2, blocks 454 and 460 of method 400 of FIG. 4, block 556 of method 500 of FIG. 5, block 660 and 658 of method 600 of FIG. 6, and/or blocks 962 and/or 966-968 of FIG. 9. The LLM response generation engine 136 can utilize one or more generative models, such as one or more LLMs 150, VLMs, image diffusion models, encoder-only transformers, decoder-only transformers, sequence-to-sequence transformers, etc.

While the element 150 is referred to in the figures as an “LLM,” as noted previously, this is not meant to be limiting. Various generative models other than LLMs may be used in various circumstances described herein. Some non-limiting examples of such generative models may include, for instance, LLMs, PaLM, BERT, LaMDA, Meena, VLMs, image diffusion models, and/or any other generative model that is encoder-only based, decoder-only based, sequence-to-sequence based and that optionally includes an attention mechanism or other memory.

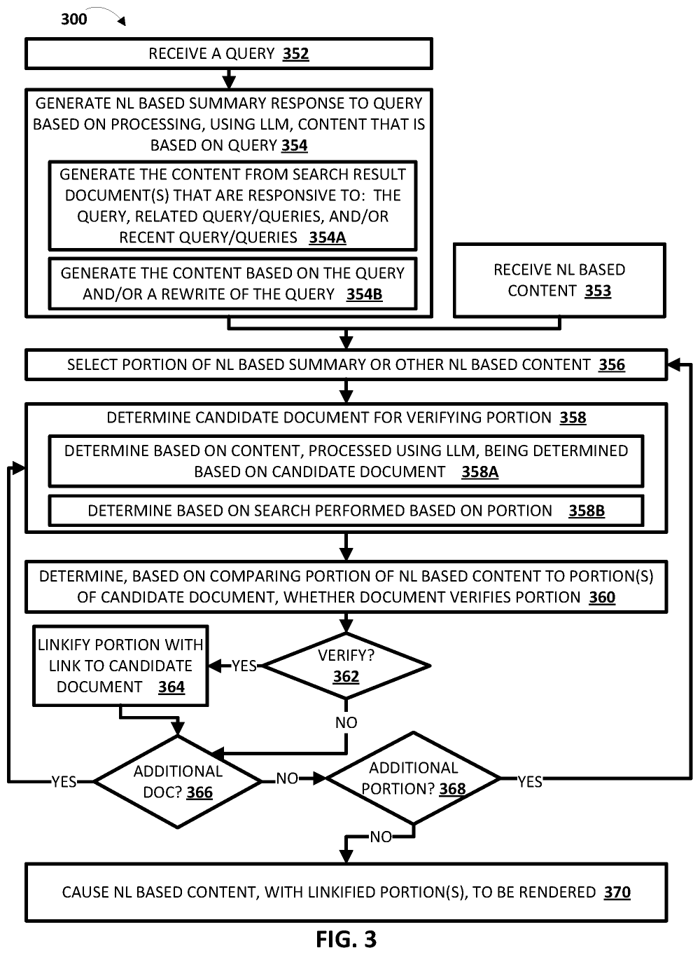

The response linkifying engine 138 can, for example, perform all or aspects of blocks 262A and 262C of method 200 of FIG. 2 and blocks 356, 358, 360, 362, 364, 366, and 368 of method 300 of FIG. 3. The response linkifying engine 138 can optionally utilize encoder(s) 158 and/or other embedding generation model(s).

The response confidence engine 140 can, for example, perform all or aspects of blocks 262B and 262C of method 200 of FIG. 2 The response confidence engine 140 can optionally utilize encoder(s) 158 and/or other embedding generation model(s).

The interaction engine 142 may be configured to monitor for interaction(s) with any of the search result document(s) that are responsive to the query. In some implementations, interaction engine 142 may be configured to perform all or aspects of block 458 of method 400 of FIG. 4.

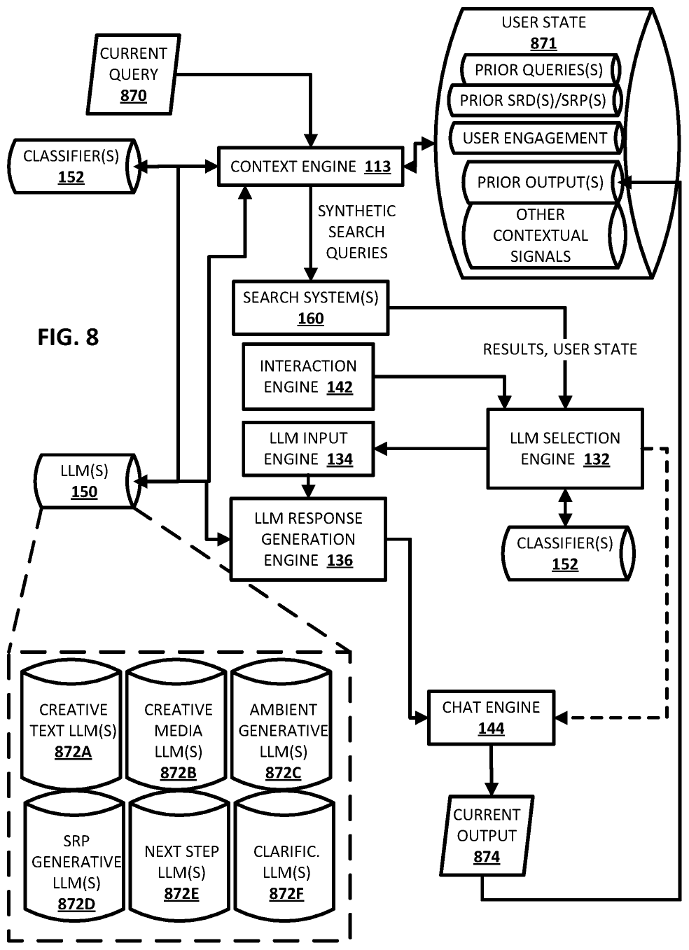

A chat engine 144 may be configured to perform selected aspects of the present disclosure to incorporate stateful chat into a user's search session, e.g., in furtherance of implementing the “generative companion.” For example, chat engine 144 may be configured to provide output(s) at the end of each “turn” of the user's search session. These output(s) may include various modalities of content, such as natural language (spoken and/or output as text), images, videos, audio, haptic feedback, and so forth. In some implementations, chat engine 144 may provide output that includes content generated by LLM response generation engine 136 using one or more LLM(s) 150. In various implementations, chat engine 144 may provide data indicative of rendered content (e.g., the content itself, embeddings generated therefrom, etc.) to other components, such as rendering engine 112 (which may actually cause the output to be rendered at client device 110), application 115, context engine 113, LLM selection engine 132, etc. In this way, chat engine 144 may facilitate a feedback loop that allows a user's state to be continuously updated across multiple turns of a search session. FIG. 8 schematically depicts one example of how chat engine 144 may perform selected aspects of the present disclosure to facilitate stateful chat to accompany a user's search session.

Search system 160 is illustrated as including a SRD engine 162, a features engine 164, and a results engine 166. Some of the engines can be omitted in various implementations.

The SRD engine 162 can, for example, utilize indices 172 and/or other resources in identifying search result documents that are responsive to queries as described herein. The feature(s) engine 164 can generate one or more of the measures, for search result documents, described herein and can optionally utilize measures database 174 in doing so. The results engine 166 can generate non-LLM generated search results that can optionally be presented along with an NL based summary described herein.

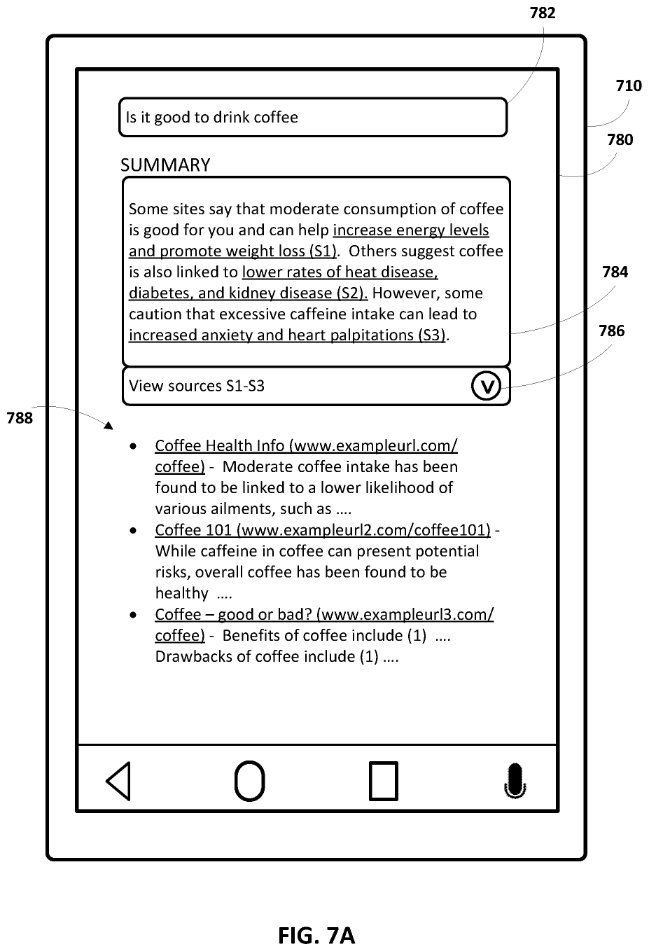

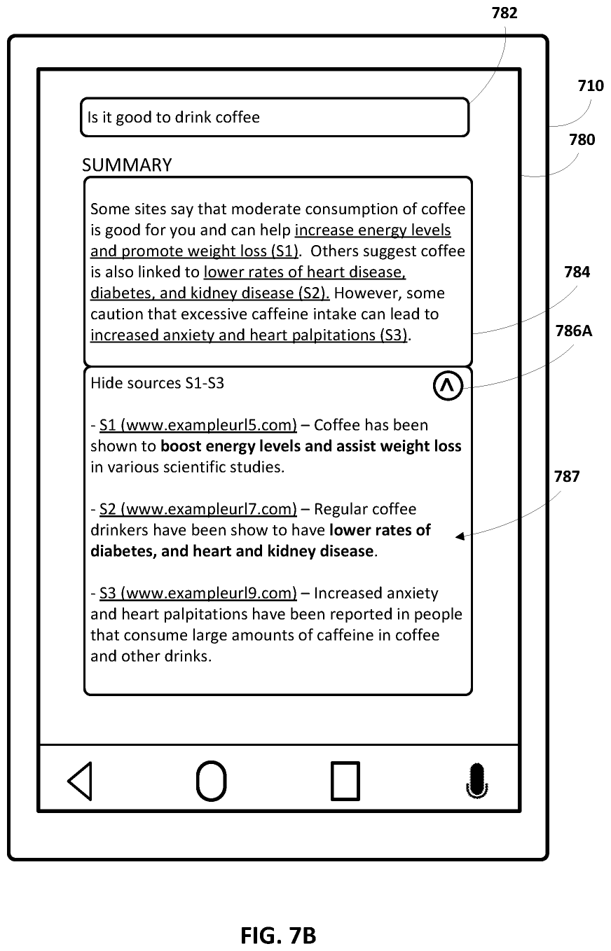

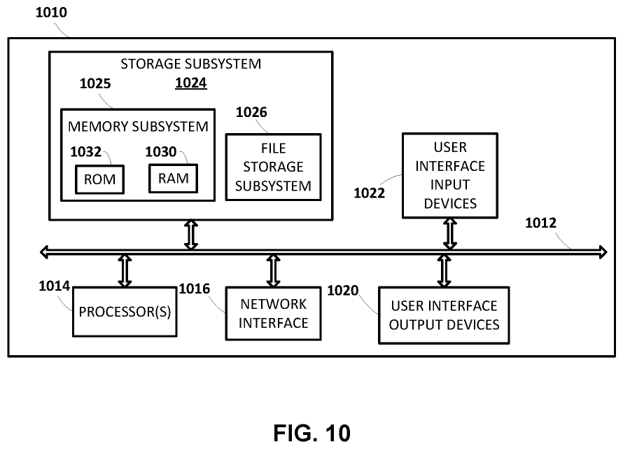

Turning now to FIG. 2, a flowchart is depicted that illustrates an example method 200 of generating, using an LLM and search result documents that are responsive to a query, an NL based summary response to the query, and causing the NL based summary to be rendered in response to the query. For convenience, the operations of the method 200 are described with reference to a system that performs the operations. This system of the method 200 includes one or more processors, memory, and/or other component(s) of computing device(s) (e.g., client device 110 of FIG. 1, client device 1010 of FIG. 10, and/or computing device 710 of FIGS. 7A and 7B, one or more servers, and/or other computing devices). Moreover, while operations of the method 200 are shown in a particular order, this is not meant to be limiting. One or more operations may be reordered, omitted, and/or added.

At block 252, the system receives a query. The query can be one formulated based on user interface input at a client device, such as typed input, voice input, input to cause an image to be captured or selected, etc. The query can be, for example, a voice query, a typed query, an image-based query, a multimodal query (e.g., that includes voice input and an image), or an inferred/parameterless query. In some implementations, when the query includes content that is not in textual format, the system can convert the query to a textual format or other format. For example, if the query is a voice query the system can perform automatic speech recognition (ASR) to convert the query to textual format. As another example, assume the query is a multimodal query that includes an image of an avocado and a voice input of “is this healthy”. In such an example, the system can perform ASR to convert the voice input to text form, can perform image processing on the image to recognize an avocado is present in the image, and can perform co-reference resolution to replace “this” with “an avocado”, resulting in a textual format query of “is an avocado healthy”.

The query can alternatively be an implied query, such as one formulated and/or submitted independent of any user input directed to formulating the implied query. For example, the query can be an implied query that is automatically generated based on profile data and that is automatically submitted. For instance, the implied query can be “machine learning”, based on profile data indicating interest in machine learning topic(s). As another example, the query can be an implied query that is automatically generated and/or automatically submitted based on a current and/or recent context. As yet another example, the query can be an implied query that is submitted based on the user providing some indication of a desire to perform a search (e.g., pushing a search button, performing a search touch gesture, accessing a particular screen or state of an application), but that is generated automatically based on content currently being displayed at a client device, location, time of day, and/or other context signal(s).

At block 254, the system selects one or more query-responsive search result documents (SRDs), that are responsive to the query of block 252, for inclusion in a set. For example, the system can select, for inclusion in the set, a subset of query-responsive SRDs that the system and/or a separate search system have identified as responsive to the query. For instance, the system can select the top N (e.g., 2, 3, or other quantity) query-responsive SRDs as determined by a search system or can select up to N query-responsive SRDs that have feature(s), as determined by the system, that satisfy one or more criteria.

In some implementations, block 254 includes sub-block 254A in which selecting the set of query-responsive SRDs can be based on query-dependent measure(s), query-independent measure(s), and/or user-dependent measure(s) for the query-responsive SRDs. In some implementations, the system includes a search system that optionally generates one or more of such measures. In some implementations, the system excludes a search system, but receives one or more of such measure(s) from the search system and/or generates one or more of such measures independent of the search system.

Query-dependent measures for a query-responsive SRD can include, for example, a positional ranking of the query-responsive search result document and for the query, a selection rate of the query-responsive search result document and for the query, a locality measure that is based on an origination location of the query and a location corresponding to the query-responsive search result document, and/or a language measure that is based on a language of the query and a language corresponding to the query-responsive search result document.

Query-independent measures for a query-responsive SRD can include, for example, a selection rate of the query-responsive search result document for multiple queries, a trustworthiness measure for the query-responsive search result document (e.g., one generated based on an author thereof, a domain thereof, and/or inbound link(s) thereto), an overall popularity measure for the query-responsive search result document, and/or a freshness measure that reflects recency of creation or updating of the query-responsive search result document.

User-dependent measures for a query-responsive SRD can be based on, for example, relation of the query-responsive search result document to: attributes of a user profile for the query; recent queries at the client device or via the user profile; and/or recent non-query interactions at the client device or via the user profile. For example, if a user profile indicates a user is a movie buff, then user-dependent measure(s) for an SRD pertaining to a movie can result in the SRD more likely being selected for inclusion in the set than if the user profile did not indicate the user is a movie buff.

It is noted that, by considering query-dependent and/or user-specific measure(s) in selecting the set at block 254A, different sets can be determined for different submissions of the same query. For example, using a locality measure can lead to a first set of query-specific SRDs for the query of “history of Louisville” submitted from Louisville, Kentucky and a distinct second set of query-specific SRDs for the query of “history of Louisville” submitted from Louisville, Colorado. As described herein, differing sets of SRD(s) will result in differing generated NL based summaries. For example, differing sets of SRDs will result in differing content, from the SRDs of the respective set, being processed using the LLM in generating the respective NL based summary. Accordingly, differing generated NL based summaries will be provided for different submissions of the same query. This enables provisioning of NL based summaries that are more likely to efficiently resolve a querying user's informational needs, and that are generated in dependence on query-dependent and/or user-specific dependent considerations (e.g., query location, query language, and/or attribute(s) of a user profile).

At optional block 256, the system selects, for inclusion in the set, one or more related-query-responsive SRDs, that are responsive to one or more related queries that are determined to be related to the query of block 252. In some implementations, whether block 256 is performed can be based on a magnitude of correlation between the query and one or more related queries (described below) and/or based on characteristic(s) of the query-responsive search result document(s) for the query. For example, block 256 can be performed based on the query-responsive search result document(s), for the query, not being diverse relative to one another, being of low quality, and/or having other characteristic(s)).

In some implementations, block 256 includes sub-block 256A, in which the system determines whether to select a related-query-responsive SRD, that is responsive to a related query, for inclusion in the set based on (a) a magnitude of correlation of the related query to the query and/or (b) measures of the related-query-responsive SRD. The (b) measures of the related-query-responsive SRD can include query-dependent measure(s) (for the related query to which the related-query-responsive SRD is responsive), query-independent measure(s) for the related-query-responsive SRD, and/or user-dependent measure(s) for the related-query-responsive SRD. The (a) magnitude of correlation of the related query to the query can reflect a strength of the correlation. For example, the (a) magnitude of correlation of the related query to the query can be based on a quantity of occurrences of the query and the related query both being issued by a corresponding device or account within temporal proximity of one another.

At optional block 258, the system selects, for inclusion in the set, one or more recent-query-responsive SRDs, that are responsive to one or more recent queries that were recently submitted by the client device that submitted the query and/or that were recently submitted by a user account that submitted the query. In some implementations, whether block 258 is performed can be based on an overlap between the query and a recent query (described below) and/or based on characteristic(s) of the query-responsive search result document(s) for the query. For example, block 258 can be performed based on the query-responsive search result document(s), for the query, not being diverse relative to one another, being of low quality, and/or having other characteristic(s)).

In some implementations, block 258 includes sub-block 258A, in which the system determines whether to select a recent-query-responsive SRD, that is responsive to a related query, for inclusion in the set based on (a) overlap between the query and recent query and/or (b) measures of the recent-query-responsive SRD. The (b) measures of the recent-query-responsive SRD can include query-dependent measure(s) (for the recent query to which the recent-query-responsive SRD is responsive), query-independent measure(s) for the recent-query-responsive SRD, and/or user-dependent measure(s) for the recent-query-responsive SRD. The (a) overlap between the query and recent query can be based on, for example, an amount of time passage between the query and the recent query and/or a degree of topical and/or entity overlap between the query and the recent query. For example, a recent-query-responsive SRD can be more likely to be selected when the recent query was issued temporally close to the query and when the recent query has topical overlap with the query.

At optional block 259, the system selects, for inclusion in the set, one or more implied-query-responsive SRDs, that are responsive to one or more implied queries. The one or more implied queries can be automatically generated based on, for example, context and/or profile data and, optionally, taking into account the query of block 252 (e.g., when the query of block 252 is based on user input). For example, an implied query can be automatically generated based on the query of block 252 and based on a current or recent context. In some implementations, whether block 259 is performed can be based on an overlap between the query and a current and/or recent context, overlap between the query and profile data, and/or based on characteristic(s) of the query-responsive search result document(s) for the query. For example, block 259 can be performed based on the query-responsive search result document(s), for the query, not being diverse relative to one another, being of low quality, and/or having other characteristic(s)).

In some implementations, block 259 includes sub-block 259A, in which the system determines whether to select an implied-query-responsive SRD, that is responsive to an implied query, for inclusion in the set based on measure(s) of the implied-query-responsive SRD. The measure(s) of the implied-query-responsive SRD can include query-dependent measure(s) (for the implied query to which the implied-query-responsive SRD is responsive), query-independent measure(s) for the implied-query-responsive SRD, and/or user-dependent measure(s) for the implied-query-responsive SRD.

At block 260, the system generates an NL based summary based on processing, using an LLM, corresponding content from each of the SRD(s) of the set determined in block(s) 256, 258, 259, and/or 260. For example, if five search result documents are selected for the set, a corresponding portion of content from each of the five can be processed using the LLM to generate the NL based summary. The content of an SRD, that is processed using the LLM, can include all of the content of the document, such as text, image(s) (e.g., auto-generated caption(s) of image(s), text for detected object(s) in image(s), text in image(s)), and/or video(s) (e.g., transcription(s) thereof) of the document—or subset(s) of content of the document. It is noted that the search result documents that are selected for the set used in block 260 can include search result document(s) from block(s) 254, 256, 258, and/or 259. For example, in some implementations or iterations the set can include search result documents from only block 254. As another example, in some implementations or iterations the set can include search result documents from only blocks 254 and 259 (i.e., SRD(s) from block 254 and additional SRD(s) from block 259). As yet another example, in some implementations or iterations the set can include search result document(s) from each of blocks 254, 256, 258, and 259 (i.e., at least one corresponding search result document from each of those blocks).

In some implementations, the LLM that is utilized in generating the NL based summary can be one that is fine-tuned to a summary prompt. In some of those implementations, no prompt is processed using the LLM along with the corresponding content from each of the SRD(s) of the set. In some other implementations, the LLM may not be fine-tuned to a summary prompt and/or a summary prompt can be processed using the LLM and along with the corresponding content from each of the SRD(s) of the set. For example, a summary prompt such as “summarize the following content” can be processed using the LLM in advance of processing the corresponding content from each of the SRD(s) of the set.

In some implementations, the NL based summary that is generated can include direct quotes from the content that is processed using the LLM and/or can paraphrase the content that is processed using the LLM. In some implementations or situations, the NL based summary that is generated can also include content that is not directly (or even indirectly) derivable from the content processed using the LLM, but is relevant to the content and is generated based on world knowledge of the LLM (obtained through prior training). In some implementations or situations, the NL based summary can include solely NL. In some implementations or situations, the NL based summary can additionally include additional content such as image(s) and/or video(s) (e.g., from SRD(s) of the set).

In some implementations, block 260 includes sub-blocks 260A and/or 260B.

At sub-block 260A, the system generates corresponding content from each SRD of the set determined in block(s) 256, 258, 259, and/or 260. For example, sub-block 260A can include further sub-block 260A1 in which the system generates the corresponding content for an SRD based on text, image(s), and/or video(s) of the SRD. For instance, the system can generate content that includes a snippet of text from the SRD as well as a caption of an image of the SRD. The snippet and/or the image can optionally be selected based on their correspondence to the query. In some implementations, at further sub-block 260A1 the system can optionally summarize the content and utilize the summarized content as the content that is processed using the LLM in generating the NL based summary. In some of those implementations, summarizing the content and utilizing the summarized content that is processed using the LLM enables the content, from the SRD and from other SRD(s) of the set, to be processed using the LLM (e.g., to conform to memory constraints of the LLM). In summarizing the content, the system can optionally process the content using a separate summarization LLM.

In some implementations, at further sub-block 260A1 the system can additionally or alternatively include, as part of the content, a source identifier of the SRD. For example, the source identifier can be a token included at the beginning and/or the end of the content. The token can be unique relative to other source identifier(s) for other SRD(s) of the set. The token can be descriptive of the underlying source document or can be non-descriptive thereof (e.g., it can be one of N default source identifiers). As described herein, in some implementations including the source identifier in the content can enable the LLM output, generated based on processing the content using the LLM, to reflect which portion(s) of the NL based summary are supported by which SRD(s).

At sub-block 2606, the system generates, based on processing the corresponding content using the LLM, LLM output that reflects the NL based summary. The NL based summary is generated based on the LLM output. In some implementations, the LLM output optionally additionally reflects source identifier(s) and/or confidence measure(s) associated with corresponding portion(s) of the NL based summary. As described herein, the source identifier(s) can be utilized in linkifying the corresponding portion(s). For example, a source identifier appearing before and/or after a portion of the NL based summary can indicate that the SRD, corresponding to the source identifier, verifies the portion. As a result, a link to the SRD can be provided in conjunction with the portion. As also described herein, the confidence measure(s) can be utilized in annotating confidence in corresponding portion(s) of the NL based summary and/or in the summary as a whole. For example, a portion with a high confidence measure can be annotated in a first color (e.g., green), a portion with a medium confidence measure can be annotated in a second color (e.g., orange), and a portion with a low confidence measure can be annotated in a third color (e.g., red).

At block 262, the system causes the NL based summary, generated at block 260, to be rendered in response to the query. For example, the system can cause the NL based summary to be rendered graphically in an interface of an application of a client device via which the query was submitted. As another example, the system can additionally or alternatively cause the NL based summary to be audible rendered via speaker(s) of a client device via which the query was submitted.

In some implementations, the system causes the NL based summary to be rendered without any rendering of any additional search results. In some other implementations, the system additionally causes rendering of additional search result(s), such as those for the SRD(s) of the set that were used in generating NL based summary and/or those for other search result(s) (i.e., SRD(S) not included in the set).

In some implementations, block 262 includes sub-block 262A, sub-block 262B, and/or sub-block 262C.

At sub-block 262A, the system causes rendering of the NL based summary with link(s) to SRD(s) that verify portion(s) of the NL based summary. For example, link(s) to one or more SRD(s) of the set can optionally be provided as part of the NL based summary, and each of the links can be a corresponding general link to the SRD or a corresponding anchor link to a specific portion of the SRD (e.g., a portion of the SRD that verifies a corresponding portion of the NL based summary). For instance, a portion, of a visually rendered NL based summary, that is supported by a first SRD can be selectable (and optionally underlined, highlighted, and/or otherwise annotated). A selection of the portion can result in navigating to a link corresponding to the first SRD. Also, for instance, an icon or other graphical element corresponding to the first SRD can be visually rendered in conjunction with (e.g., presented immediately after) the portion of the NL based summary and can optionally be selectable to cause navigation to the link corresponding to the first SRD. As yet another instance, when multiple SRDs verify a portion of the NL based summary, a respective icon (or other graphical element) for each can be visually rendered in conjunction with the portion of the NL based summary and can optionally be selectable to cause navigation to a corresponding link for the corresponding SRD. For instance, if the portion is verified by a first SRD and a second SRD, a first icon for the first SRD and a second icon for the second SRD can be visually rendered immediately after the portion, the first icon can be selectable to cause navigation to a first link for the first SRD, and the second icon can be selectable to cause navigation to a second link for the second SRD.

At sub-block 262B, the system causes rendering of the NL based summary with confidence annotation(s). For example, a textual “high confidence”, “medium confidence”, or “low confidence” annotation can be annotated for the NL based summary as a whole. As another example, each of multiple portions of the NL based summary can be annotated with a corresponding color (or other annotation) that reflects a degree of confidence in that portion.

At sub-block 262C, the system uses the LLM output and/or comparison(s) in (a) determining SRD(s) that verify portions of the NL based summary (for use in sub-block 262A) and/or in (b) determining confidence annotation(s) (for use in sub-block 262B).

For example, in determining that an SRD verifies a portion of an NL based summary, the system can use LLM output, such as LLM output that includes a source identifier for the SRD and that corresponds to the portion. As another example, in determining that an SRD verifies a portion of an NL based summary, the system can additionally or alternatively compare content of the portion to content of the SRD. For example, the system can compare an embedding of the portion of the NL based summary to an embedding of a portion of the SRD to determine a distance measure (e.g., in embedding space) and determine the SRD verifies the portion of NL based summary if the distance measure satisfies a threshold. For instance, the system can compare a text embedding, of a textual portion of the NL based summary, to a text embedding of a portion of the SRD, and determine whether a distance measure between the two text embedding satisfies a distance threshold.

As another example, in determining a confidence measure of a portion of an NL based summary (and a corresponding annotation to apply), the system can determine the confidence measure based on LLM confidence for that portion, as reflected in the LLM output, and/or based on underlying SRD(s) determined to verify that portion. For example the confidence measure of a portion can be based on trustworthiness of the SRD(s)) that verify that portion and/or a quantity of the SRD(s) that verify that portion. For instance, the confidence measure can reflect greater confidence when four SRDs verify that portion than when only one SRD verifies that portion. Also, for instance, the confidence measure can reflect greater confidence when four highly trustworthy SRDs verify that portion than when four less trustworthy SRDs verify that portion.

As another example, in determining a confidence measure of the NL based summary as a whole (and a corresponding annotation to apply), the system can determine the confidence measure on LLM confidence for the NL based summary as a whole, as reflected in the LLM output, and/or based on confidence of confidence of all SRD(s) used in generating the NL based summary.

Turning now to FIG. 3, a flowchart is depicted that illustrates an example method 300 of selectively linkifying portion(s) of NL based content (e.g., an NL based summary) with link(s) to document(s) that verify the portion(s). For convenience, the operations of the method 300 are described with reference to a system that performs the operations. This system of the method 300 includes one or more processors, memory, and/or other component(s) of computing device(s) (e.g., client device 110 of FIG. 1, client device 1010 of FIG. 10, and/or computing device 710 of FIGS. 7A and 7B, one or more servers, and/or other computing devices). Moreover, while operations of the method 300 are shown in a particular order, this is not meant to be limiting. One or more operations may be reordered, omitted, and/or added.

In some implementations or iterations of method 300, blocks 352 and 354 (described below) are performed without block 353 (described below) being performed. Accordingly, in those implementations the system receives a query and generates an NL based summary response, to the query, based on processing, using an LLM, content that is based on the query. In some other implementations or iterations of method 300, block 353 is performed, without blocks 352 and 354 being performed. Accordingly, in those implementations the system receives NL based content, such as a generated NL based summary or other NL based content, such as NL based content that is proactively pushed to the system or provided to the system responsive to a request by the system.

At block 352, the system receives a query. Block 352 can include one or more aspects in common with block 252 of method 200 of FIG. 2.

At block 354, the system generates an NL based summary response to the query based on processing, using an LLM, content that is based on the query. For example, the system can generate the NL based summary based on LLM output generated based on processing the content using the LLM. In some implementations, block 354 includes sub-block 354A or sub-block 354B.

At sub-block 354A, the system generates the content, that is processed using the LLM, from SRD(s) that are responsive to: the query of block 352, one or more related queries, and/or recent queries. In some implementations, sub-block 354A can include block 254 of method 200 of FIG. 2 and, optionally, block 256 and/or block 258 of method 200 of FIG. 2. In some of those implementations, block 354A can include block 260 of method 200 of FIG. 2.

At sub-block 354B, the system generates the content based on the query and/or a rewrite of the query. In some implementations, at sub-block 354B the content is generated independent of any SRD(s) that are responsive to: the query of block 352, one or more related queries, and/or recent queries. For example, the content can include only the query and/or the rewrite and, optionally, a prompt.

At block 353, the system receives NL based content, such text or other NL based content that is proactively pushed to the system or that is provided to the system responsive to a request by the system.

At block 356, the system selects a portion of the NL based summary or other NL based content. The NL based content can be an NL based summary generated at block 354, or an NL based summary or other NL based content received at block 353.

At block 358, the system determines a candidate document for verifying the portion of the NL based content. In some implementations or iterations, block 358 includes sub-block 358A or sub-block 358B.

At sub-block 358A, the system determines the candidate document based on content, that is processed using the LLM in generating a NL based summary, being determined based on the candidate document. For example, sub-block 358A can be performed, in at least some iterations, when sub-block 354A is performed. Optionally, sub-block 358A is not performed when sub-block 354b is performed.

At sub-block 358B, the system determines the candidate document based on a search performed based on the portion of the NL based content. For example, the candidate document can be determined based on it corresponding to the top search result for such a search, or being in the top N search results. As another example, the candidate document can be determined based on other measure(s) for the document, such as query-dependent, query-independent, and/or user-specific measure(s) described herein.

At block 360, the system determines, based on comparing the portion of the NL based content to portion(s) of the candidate document, whether the document verifies the portion of the NL based summary. For example, in comparing the portion of content to the document content the system can: process a portion of the NL based content, using an encoder model, to generate a content embedding of the portion; processing document content of the candidate document, using the encoder model, to generate a document content embedding; and compare the content embedding to the document content embedding. Further, in determining whether the document verifies the portion of the NL based content the system can determine a distance measure between the content embedding and the document content embedding and determining, based on the distance measure, whether the document verifies the portion of the NL based content (e.g., verifies only if distance measure is less than a threshold).

At block 362, the system proceeds to block 364 if it is determined the document verifies the portion of the NL based content, and proceeds to block 366 if not.

At block 364, the system linkifies the portion with a link to the candidate document. For example, the system can associate the portion with the link so that, when the NL based content is rendered, a selectable version of the link is rendered at the client device as corresponding to the portion. The link to the candidate document can be a general link to the candidate document or a corresponding anchor link (or other specific link) to a portion of the candidate document. The specific link can be to the portion of the candidate document based on the portion of the candidate document being determined, at block 360, to be the portion that verifies the portion of the NL based content.

At block 366, the system determines whether there are additional candidate documents to process for the portion. For example, if a document has already been determined to verify the portion, the decision at block 366 can be “no”. As another example, if N documents have already been processed for the portion, the decision at block 366 can be “no”. It is noted that in some implementations, the decision at block 366 can be “yes” even when a document has already been determined to verify the portion. In those implementations, a portion can be linkified with links to multiple candidate documents. For example, the portion can be linkified with a first link to a first candidate document in one iteration of block 364 for the portion and the portion can be linked with a second document in another iteration of block 364 for the portion. If the decision at block 366 is “yes”, the system returns to block 358 and determines an additional candidate document for the portion.

If the decision at block 366 is “no”, the system proceeds to block 368 and determines whether there are any unprocessed portion(s) of the NL based content. If so, the system proceeds to block 356 and selects an additional unprocessed portion. If not, the system proceeds to block 370.

At block 370, the system causes the NL based content, with the linkified portion(s) (if any were linkified in block 364) to be rendered. In some implementations, when block 353 is performed, at block 370 the system can transmit, in response to receiving the NL based content at block 353, data that enables rendering of the NL based content with the linkified portion(s) (if any). For example, the system can transmit at least the determined link(s) and, for each of the links, an indication of a corresponding portion of the NL based content to which it corresponds. As another example, the system can transmit the linkified NL based content. In some implementations, when blocks 352 and 354 are performed, at block 370 the system causes the NL based summary, with the linkified portion(s) (if any were linkified in block 364) to be rendered in response to the query of block 352. For example, when the NL based summary is rendered in response to the query, the system can cause a selectable link, to a corresponding document, to be rendered as corresponding to a corresponding linkified portion. For instance, the link can be rendered as corresponding to the linkified portion based on being rendered as a selectable icon following the linkified portion and the linkified portion being highlighted (or otherwise annotated). As another instance, the link can be rendered as corresponding to the linkified portion based on the linkified portion being a hyperlink for the link.

For ease in explanation, iterations of blocks 356, 358, 360, 362, 364, 366, and 368 are illustrated as being performed in serial. However, it is noted that in various implementations multiple candidate documents for a given portion and/or multiple portions can be processed in parallel.

Turning now to FIG. 4, a flowchart is depicted that illustrates an example method 400 of generating, using an LLM, a revised NL based summary response to a query, where the revised NL based summary response is generated in response to user interaction with search result document(s) that are responsive to the query. For convenience, the operations of the method 400 are described with reference to a system that performs the operations. This system of the method 400 includes one or more processors, memory, and/or other component(s) of computing device(s) (e.g., client device 110 of FIG. 1, client device 1010 of FIG. 10, and/or computing device 710 of FIGS. 7A and 7B, one or more servers, and/or other computing devices). Moreover, while operations of the method 400 are shown in a particular order, this is not meant to be limiting. One or more operations may be reordered, omitted, and/or added.

At block 452, the system receives a query. Block 452 can include one or more aspects in common with block 252 of method 200 of FIG. 2.

At block 454, the system generates an NL based summary response to the query based on processing, using an LLM, content that is based on the query. For example, the system can generate the NL based summary based on LLM output generated based on processing the content using the LLM. In some implementations, block 454 includes sub-block 454A or sub-block 454B.

At sub-block 454A, the system generates the content, that is processed using the LLM, from SRD(s) that are responsive to: the query of block 452, one or more related queries, and/or recent queries. In some implementations, sub-block 454A can include block 254 of method 200 of FIG. 2 and, optionally, block 256 and/or block 258 of method 200 of FIG. 2. In some of those implementations, block 454A can include block 260 of method 200 of FIG. 2.

At sub-block 454B, the system generates the content based on the query and/or a rewrite of the query. In some implementations, at sub-block 454B the content is generated independent of any SRD(s) that are responsive to: the query of block 452, one or more related queries, and/or recent queries. For example, the content can include only the query and/or the rewrite and, optionally, a prompt.

At block 456, the system causes, in response to the query, the NL based summary to be rendered (i.e., at the client device that submitted the query and/or a related client device), along with links to search result documents that are responsive to the query. In some implementations, some or all of the links are rendered separate from the NL based summary, such as links in traditional search results. In some implementations, some or all of the links are rendered as part of the NL based summary. For example, the links can be rendered as part of the NL based summary utilizing method 300 of FIG. 3 or block 262A of method 200 of FIG. 2.

At block 458, the system monitors for interaction(s) with any of the search result document(s) that are responsive to the query. For example, the system can determine an interaction with a search result document based on determining a selection of the corresponding link, optionally along with determining a threshold duration of dwell time at the search result document and/or other threshold interaction measure(s) with the search result document. As another example, the system can determine an interaction with a search result document based on determining that a corresponding search result document, for the search result, has been reviewed (without necessarily clicking through to the underlying search result document). For instance, the system can determine an interaction with a search result based on pausing of scrolling over the search result, expanding of the search result, highlighting of the search result, and/or other factor(s).

The system proceeds to block 460 if an interaction with search result document(s) is determined at block 458. At block 460, the system generates a revised NL based summary based on processing revised input using the LLM or an additional LLM. The revised input reflects the occurrence of the interaction(s) with the search result document(s), and is revised relative to the input that is processed, using the LLM, in block 454. The revised input can reflect familiarity with content of the search result document(s) interacted with and, as a result, the revised NL based summary will be updated in view of that familiarity. For example, the revised NL based summary can omit content of the search result document(s) interacted with (whereas the NL based summary of block 454 included it), or the revised NL based summary can include a more in depth discussion of the content of the search result document(s) interacted with (whereas the NL based summary of block 454 included only a high level overview of the content) the occurrence of the interaction(s) with the search result document(s).

In some implementations, block 460 includes sub-block 460A or sub-block 460B.

At sub-block 460A, the system generates the revised NL based summary using the same LLM as used in block 454, but using a revised input with a revised prompt that reflects familiarity with the content of the SRD(s) interacted with. For example, the prompt used in block 454 could be “create a summary of the following”, whereas the prompt used in sub-block 460A could be “create a summary of the following and assuming the user already knows X”, where “X” is a description of the content of the SRD(s) interacted with.

At sub-block 4606, the system generates the revised NL based summary using an additional LLM, relative to the one used in block 454, that is fine-tuned based on a prompt that reflects familiarity with content of the SRD(s) interacted with. For example, the fine-tuned LLM model can be trained to receive known content that the user already knows, followed by (e.g., after a delimiter) additional content to be summarized in view of the known content. For instance, the known content portion of the input can be based on content from the given search result.

At block 462, the system causes the revised NL based summary, generated at block 460, to be rendered (i.e., at the client device that submitted the query and/or a related client device). In some implementations, block 462 can include sub-block 462A and/or sub-block 462B.

At sub-block 462A, the system causes the revised NL based summary to supplant the initial NL based summary. For example, after interaction with the SRD(s), the client device can navigate back to the interface where the initial NL based summary was displayed, but it can be supplanted with the revised NL based summary.

At sub-block 462B, the system causes the revised NL based summary to be rendered in response to another occurrence of the query or a similar query. For example, after interaction with the SRD(s), the user may submit the same query again (e.g., minutes, hours, or days later), and the revised NL based summary can be rendered responsive to the additional submission of the same query and in lieu of rendering of the NL based summary of block 454.

It is noted that implementations of method 400 enable an NL based summary for a query to evolve as a user interacts with search results for the query, thereby guiding the user-to-computer interaction to direct the user to additional facets of the query and/or to a more complete understanding of the information and/or task(s) sought by the query.

Turning now to FIG. 5, a flowchart is depicted that illustrates an example method 500 of selecting none, one, or multiple generative model(s) to utilize in generating response(s) to render responsive to a query, and using the selected generative model(s), if any, in generating response(s) to the query. For convenience, the operations of the method 500 are described with reference to a system that performs the operations. This system of the method 500 includes one or more processors, memory, and/or other component(s) of computing device(s) (e.g., client device 110 of FIG. 1, client device 1010 of FIG. 10, and/or computing device 710 of FIGS. 7A and 7B, one or more servers, and/or other computing devices). Moreover, while operations of the method 500 are shown in a particular order, this is not meant to be limiting. One or more operations may be reordered, omitted, and/or added.

At block 552, the system receives a query. Block 552 can include one or more aspects in common with block 252 of method 200 of FIG. 2.

At block 554, the system selects, from multiple candidate generative models: none, one, or multiple to utilize in generating response(s) to render responsive to the query. For example, in some iterations the system will determine to not utilize any of the candidate generative models, in some iterations the system will determine to utilize only one of the candidate generative models, and in some iterations the system will determine to utilize multiple of the candidate generative models.

As a working example, assume the candidate generative models include: an informational LLM for generating informational summaries for a query; a creative LLM for generating creative poems, essays, or other prose based on a query; and a text-to-image diffusion model for creating a synthetic image based on a query. In some implementations, the creative LLM and the informational LLM can be two truly different LLMs, such as an informational LLM fine-tuned to a summary prompt and a creative LLM fine-tuned to a prompt that corresponds to the query (e.g., a “writing” LLM if query includes “write me an essay about” or “write me a poem about). In some other implementations, the creative LLM and the informational LLM can be the same LLM, but prompted differently (e.g., prompt with “summarize the following passages” if informational; prompt based on query (or rewrite) if creative).

Block 554 can include sub-block 554A, in which the system makes the selection of block 554 based on processing the query and/or based on processing responsive search result document(s) that are responsive to the query. Sub-block 554A can include sub-block 554A1 in which the system uses a classifier and/or rules in the processing of sub-block 554A.

For example, the system can process content of the query using a machine learning classifier to classify the query into one or more classifications, and the generative model(s) corresponding to those classification(s) can be determined to be most appropriate. For example, the query can be processed using a classifier to classify the query among the generative models (e.g., as one of informational, creative, or synthetic image). As another example, the system can additionally or alternatively utilize a rule that specifies classification(s) that vary in dependence on presence and/or absence of certain words. As yet another example, for a voice query, the system can additionally or alternatively utilize voice characteristic(s) of the query to classify the query among the generative models. As another example, the system can additionally or alternatively utilize SRD(s), that are responsive to the query, to classify the query among the generative models. For example, if top N result(s) include certain type(s) of results and/or result(s) that include certain type(s) of content, the system can determine an informational LLM should be used. As another example, if top N result(s) include certain other type(s) of results and/or result(s) that include certain other type(s) of content, the system can determine a creative LLM and a text-to-image diffusion model should be used. As yet another example, the system can consider the quality and/or trustworthiness of SRD(s). As yet another example, for “close calls” (e.g., based on classifier output(s)) and/or in other situations, the system can select multiple generative models that correspond to the “close calls”—or for “close calls” and/or in other situations (e.g., search result(s) for the query are high quality), the system can determine to select no generative model(s) for use in generating responses.

At block 556, the system uses the selected generative model(s) (selected at block 554), if any, in generating response(s) to render responsive to the query. For example, if only an informational LLM is selected, an NL based summary response can be generated using the informational LLM. As another example, if both the creative LLM and the text-to-image diffusion model are selected, a creative prose response can be generated using the creative LLM and a synthetic image response can be generated using the text-to-image diffusion model.

At block 558, the system causes, in response to the query, any generated response(s) (generated at block 556) to be rendered (i.e., at the client device that submitted the query and/or a related client device). The response(s) can optionally be rendered along with additional search results for the query, such as those not generated utilizing any of the candidate generative models.

Turning now to FIG. 6, a flowchart is depicted that illustrates an example method 600 of generating, using an LLM, an NL based summary in dependence on whether a submitter of the query is already familiar with certain content that is responsive to the query. For convenience, the operations of the method 600 are described with reference to a system that performs the operations. This system of the method 600 includes one or more processors, memory, and/or other component(s) of computing device(s) (e.g., client device 110 of FIG. 1, client device 1010 of FIG. 10, and/or computing device 710 of FIGS. 7A and 7B, one or more servers, and/or other computing devices). Moreover, while operations of the method 600 are shown in a particular order, this is not meant to be limiting. One or more operations may be reordered, omitted, and/or added.

At block 652, the system receives a query. Block 652 can include one or more aspects in common with block 252 of method 200 of FIG. 2.

At block 654, the system determines, based on a profile associated with the query (e.g., a device profile of the client device via which the query was submitted and/or a user profile of the submitter), whether the submitter of the query is already familiar with certain content that is responsive to the query. Block 654 can include sub-block 654A. At sub-block 654A, the system, in determining whether the submitter of the query is already familiar with the certain content, compares profile data, of the profile, to the query and/or to search result document(s) that are responsive to the query and/or to one or more related queries. For example, the system can determine that the user is already familiar with the certain content if the comparison indicates the user has already interacted with search result document(s) having the certain content and/or has profile data that directly indicates familiarity with the certain content.

At block 656, the system determines to proceed to block 660 if the system determined at block 654 that the user is not familiar with the certain content, and determines to proceed to block 658 if the system determined at block 654 that the user is familiar with the certain content.

At block 660, the system generates an NL based summary based on LLM processing of input that does not reflect familiarity with the certain content.

At block 658, the system generates an NL based summary based on LLM processing of input that reflects familiarity with the certain content. Block 658 can include sub-block 658A or sub-block 658B.

At sub-block 658A the system generates the NL based summary using input that reflects familiarity with the certain content, such as input that includes a prompt of “assuming the user is familiar with [description of the certain content] give me a summary of [query]”.

At sub-block 658B, the system generates the NL based summary using an LLM fine-tuned based on a prompt that reflects familiarity with the content, and using input formatted for the fine-tuned LLM. For example, the fine-tuned LLM model can be trained to receive known content that the user is already familiar with, followed by (e.g., after a delimiter) additional content to be summarized in view of the known content.

At block 662, the system causes the generated NL based summary to be rendered. The generated NL based summary can be one generated in block 660 or one generated in block 658.

In some implementations, after performing block 662, the system can proceed to block 458 of method 400 of FIG. 4. Further, if interaction(s) with SRD(s) are determined at block 458 of method 400 of FIG. 4, the system can further proceed to blocks 460 and 462 of FIG. 4. Put another way, the techniques of FIG. 4 and FIG. 6 can be combined in some implementations. In those implementations, this enables an initially generated NL based summary for a query to be selectively generated based on familiarity of a user with certain content that is responsive to the query and, further, enables a revised NL based summary for the query to be generated responsive to further interaction(s) with search result document(s). For example, an initially generated NL based summary can be generated with a prompt that reflects familiarity with content X (but not content Y), based on a profile indicating the user is already familiar with content X. Further, the user can thereafter interact with search result document(s) that relate to content X and, in response, a revised NL based summary can be generated with a prompt that reflects familiarity with content X and with content Y.

FIG. 7A depicts an example client device 710 with a display 780 rendering, in response to a query 782, a graphical interface that includes an example NL based summary 784 and additional example search results 788 that are responsive to a query. In the NL based summary 784, there are three linkified portions, each indicated by underlining and a source identifier (S1, S2, S3) provided immediately following the linkified portions. Each linkified portion, and its source identifier, is selectable to cause navigation to a corresponding search result document that verifies the linkified portion. Further, in FIG. 7A there is an expansion element 786 displayed that, when selected, reveals search results for the search result document(s) that verify the linkified portions of the NL based summary 784.

Three example search results 788 are illustrated in FIG. 7A below the NL based summary 784. The three search results 788 can be, for example, the top 3 search results for the query 782. Additional search results can be provided (e.g., by scrolling down) or, in some implementations, search results 788 can be omitted or only shown in response to a user scrolling, selecting an interface element, or providing other input(s). It is noted that, in the example of FIG. 7A, the search results 788 correspond to search result documents that are distinct from the search result documents that correspond to the source identifiers (S1, S2, S3) that verify linkified portions of the NL based summary 784. For example, and as illustrated in FIG. 7B, the search result documents that correspond to the source identifiers (S1, S2, S3) are associated with uniform resource locators (URLs) that differ from those of the search results 788. Search result(s), that correspond to the search result documents that correspond to the source identifiers (S1, S2, S3), can optionally be included among additional search results provided by e.g., scrolling down—or could even be included among the top 3 search results in various situations.

FIG. 7B depicts the example client device 710, after a user has interacted with the expansion element 786 of FIG. 7A to reveal search results 787 for the search result document(s) that verify the linkified portions of the NL based summary. A contraction element 786A is also illustrated that, when selected, causes the interface to revert back to its FIG. 7A state.

In some implementations disclosed herein, multiple LLMs are utilized in parallel in generating an NL based summary responsive to a query. For example, each of the multiple LLMS can be utilized to generate a corresponding candidate NL based summary, but only one of the candidate NL based summaries selected for use (e.g., for rendering in response to the query). For instance, one can be selected for use based on it (a) being similar to the greatest quantity of other candidate NL based summaries, (b) being similar to at least a threshold quantity of other candidate NL based summaries, (c) lacking certain content (e.g., certain term(s)), (d) including certain content (e.g., certain term(s)), (d) having the highest language model score, (e) having a language model score that satisfies a threshold, and/or (f) having or lacking other feature(s).

In some versions of those implementations, one or more of the LLMs that are utilized in parallel can be truly different from other of the LLM(s). For example, a first of the LLMs can be trained and/or fine-tuned differently than a second of the LLMs. Also, for example, each of the LLMs can be trained and/or fine-tuned differently than all other of the LLMs. As another example, a first of the LLMs can have a first architecture that differs from a second architecture of a second of the LLMs. In some additional or alternative versions of those implementations, two or more (e.g., all) of the LLMs that are utilized in parallel are the same (e.g., architecturally, training, and/or fine-tuning wise), but different content is processed among the two or more LLMs. For example, first search result document(s) can be processed using a first LLM and second search result document(s) can be processed using a second LLM.

As another example, a first subset of content from first search result document(s) can be processed using a first LLM and a second subset of content from the first search result document(s) can be processed using a second LLM. As yet another example, a first prompt can be processed (along with additional content) using a first LLM and a second prompt can be processed (optionally along with the same additional content) using a second LLM. Utilizing multiple LLMs in parallel for a given query, while optionally selecting a candidate NL based summary from only one, can mitigate occurrences of the selected candidate NL based summary being difficult to parse, inaccurate, or otherwise not resonating with a user. Put another way, running multiple LLMs in parallel can leverage that different LLMs may perform better in some situations than others, and enables utilizing output from the LLM that is best suited for the current situation.

In some implementations disclosed herein, multiple LLMs are utilized in series in generating an NL based summary responsive to a query. As one example, first LLM(s) can be used to select passages from a set of search result document(s) (e.g., utilized in block 260A of method 200 of FIG. 2). Second LLM(s) can then be used to generate a summary for each of the passage(s) selected utilizing the first LLM(s) (e.g., utilized in block 260A1 of method 200 of FIG. 2). Further, third LLM(s) can then generate an overall NL based summary based on the individual passage summaries generated using the second LLM(s) (e.g., utilized in block 260B of method 200 of FIG. 2).

In some implementations, a user can specify, as part of a query or via interface element(s) in conjunction with a query (e.g., selectable interface element(s) provided near a query input field), desired formatting option(s) for an NL based summary. For example, a desired formatting option could be “list format”, “graph format”, “top 5”, “in the style of”, etc. For instance, a query could be “how to draft a patent, in list format” or “how to draft a patent, in the style of a layperson”, etc. In some versions of those implementations, the specified format can be used to select, from plurality of fine-tuned LLMs for each format, a fine-tuned LLM for the selected format. For example, if “list format” is specified, an LLM that is fine-tuned on a list format prompt can be selected as the LLM to utilize in generating a NL based summary according to implementations disclosed herein. In some additional or alternative versions, the specified format can be used to adapt a prompt for an LLM. For example, if “graph” format is specified, a prompt provided to the LLM in generating the NL based summary can be e.g., “summarize the following information in graph format”.

Client device 710 can include various user interface components including, for example, microphone(s) to generate audio data based on spoken utterances and/or other audible input, speaker(s) to audibly render synthesized speech and/or other audible output, and/or the display 780 to visually render visual output. Further, the display 780 of the client device 710 can include various system interface elements (e.g., hardware and/or software interface elements) that may be interacted with by a user of the client device 710 to cause the client device 710 to perform one or more actions. The display 780 of the client device 710 enables the user to interact with content rendered on the display 780 by touch input (e.g., by directing user input to the display 780 or portions thereof (e.g., to a query entry box), to a keyboard (not depicted), or to other portions of the display 780)) and/or by spoken input (e.g., by selecting microphone interface element—or just by speaking without necessarily selecting a microphone interface element). Although the client device 710 depicted in FIG. 7 is a mobile phone, it should be understood that is for the sake of example and is not meant to be limiting. For example, the client device 710 may be a standalone speaker with a display, a standalone speaker without a display, a home automation device, an in-vehicle system, a laptop, a desktop computer, and/or any other device.

FIG. 8 schematically depicts an example of how various components depicted in prior figures may cooperate to implement what is referred to herein as a “generative companion” that provides a stateful chat experience for a user during a search session. As shown in FIG. 8, this generative companion may be wholly or partially implemented and/or controlled by chat engine 144.

Starting at top left, in various implementations, a current query 870 may be received at a client device (not depicted in FIG. 8, see 110 in FIG. 1). In various implementations, the current query 870 can be a voice query, typed query, image-based query, multimodal (e.g., voice+image), and/or an inferred/parameterless query. If current query 870 includes an image, in some implementations, the image can be converted to text, e.g., using a machine learning model trained to generate image captions, a machine learning model trained to detect objects in images, etc. This text may then be utilized as NL-based input (e.g., using captioning model, object detection model(s), etc.). In other implementations, the image may be encoded as a semantically rich embedding that can be combined with other embeddings and/or data structures, such as current state 871 of the user.

In some implementations, a user can provide the generative companion with permission to access the user's personal content, such as the user's personal digital images, videos, audio recordings, documents, etc. That may allow the generative companion to generate, for instance, synthetic images that are based at least in part on the user's personal digital images, as opposed to being based entirely on images that were used to train one or more LLM(s) previously.

Context engine 113 may be configured to retrieve relevant contextual information for use in resolving current query 870. Much of what context engine 113 retrieves may be part of the user state 871. As shown in FIG. 8, user state 871 may include a variety of different data points. In some implementations, one or more prior queries of the user, from the current session and/or from one or more prior search sessions, may be retrieved/consulted.

Prior SRD(s) and/or SRP(s) and/or data indicative thereof (e.g., summaries, captions, embeddings generated therefrom, etc.) from the current and/or prior search sessions may also be retrieved by context engine 113. In some implementations, this data may include, for instance, titles of documents, passages of text that accompany links on SRDs, snippets from SRDs, etc.

User state 871 may also include information about user engagement with documents/media during the current search session and/or during previous search sessions. Content of these engaged document/media can be used to enrich user state 871, influence subsequent data generation by various LLM(s), etc. For example, if the user has previously accessed and viewed a particular document, the content of that document may be accounted for as being “known” by the user moving forward. Thus, for instance, automatically-generated search queries may seek documents having details that were not contained in the viewed document. As another example, the user may tend to view particular types of documents (e.g., text-based documents) more frequently than other types of documents (e.g., videos), suggesting that the user prefers a particular type of document. This preference may be encoded into the user state such that search queries generated by context engine 113 will seek out the preferred document type (e.g., textual content) and/or exclude non-preferred document types (e.g., videos).

Prior outputs generated, e.g., by a search engine, LLM response generation engine 136, and/or by chat engine 144, may also be retrieved by context engine 113 from user state 871. As one example of a prior output, summarizations of SRD(s) and/or SRP(s) presented previously during a current session or during a previous session may be retrieved, e.g., in the form previously presented (e.g., paragraph, prose), as a semantically rich reduced dimensionality embedding, etc. As another example of a prior output, NL chat output generated by the generative companion, e.g., to directly answer a question of the user during a previous turn of the search session, may be retrieved by context engine 113.

In some implementations, user state 871 may be represented as one or more a semantically rich embeddings. For example, user state 871 may include different embeddings for different pieces of information, such as one embedding for a prior query, another embedding for the user's location, another embedding for a SRD summarized for the user, etc. In some such implementations, these embeddings may be created, e.g., by LLM input engine 134, as tokens that are applied, e.g., by LLM response generation engine 136, as inputs across LLM(s).

In other implementations, user state 871 may be represented as a data structure that includes prior queries, tokens, keywords, etc. For example, suppose a user starts a search session by asking, “find me a hotel in Boise, Idaho.” The tokens {hotel, Boise, Idaho} may be added to user state 871. If the user next says, “But I need Wi-Fi and a pool,” then the tokens {Wi-Fi, pool} may be added to user state 871, resulting in a total state of {hotel, Boise, Idaho, Wi-Fi, pool}.

As another example, suppose a user starts a search session by asking, “find me a recipe for chicken salad.” The tokens {recipe, chicken, salad} may be added to user state 871. If the user next says, “wait, let's make it vegetarian,” then the token {chicken} may be removed from user state 871 and the token {vegetarian} may be added to user state 871, resulting in a total state of {recipe, salad, vegetarian}.

In some implementations, it may be possible for a user to resume a previous search session. In some cases the user may do so by selecting from a list of prior search sessions. In other instances, the prior search session may be resumed based on the most recent query issued by the user and/or based on various contextual signals. For instance, current query 870 can be matched, e.g., by context engine 113, to prior search sessions automatically based on similarity (e.g., distance in embedding space) between current query 870, a prior search session context, and/or based on a current context.

Referring back to user state 871, other contextual signals determined, e.g., from a device operated by the user and/or online resources controlled by the user, may also be considered. For example, attributes and/or preferences of the user, such as dietary restrictions, explicitly stated preferences, musical preferences, habits and tendencies (e.g., tendency to eschew video SRDs in favor of textual SRDs), etc., may be maintained as part of user state 871. User state may also include a variety of contextual signals that may be determined from the user's device and/or from resources controlled by the user, such as the user's past, present, or future location (e.g., position coordinates output by a GPS sensor), a time of day (e.g., in a time zone associated with the user's location), the user's social media status, a current detected activity (e.g., driving, exercising, studying, working) of the user, a schedule of the user determined from an electronic calendar and/or electronic correspondence (e.g., email), and so forth.

Once context engine 113 has ingested current query 870 and the current user state 871, context engine 133 may automatically generate, responsive to receiving current query 870 and using generative model(s) (e.g., LLM(s)), one or more “rewritten” and/or “optimized” search queries (collectively, “synthetic” search queries). In various implementations, the synthetic search queries may share various characteristics with the implied queries generated by implied input engine 114. In some implementations, particularly where current query 870 is long and/or complex (determined, for instance, by a count of terms, vocabulary classification provide by a machine learning classifier trained to assign vocabulary classifications to text, etc.), a single synthetic search query may be generated by context engine 113 that simplifies or otherwise rewrites current search query 870 (e.g., reordering terms, enclosing multiple terms in quotes to achieve narrower results, etc.). Additionally or alternatively, multiple synthetic search queries may be generated for downstream execution, e.g., to provide a step-by-step drill down into a topic of interest during the current search session.

In some cases, synthetic search queries generated by context engine 113 may include additional search terms or phrases not contained in the user's current query. These additional search terms or phrases may be gleaned from the various contextual data described above. For example, if current query 870 is matched to a prior search session (or the user explicitly resumes a prior search session), the generated synthetic search queries may drill down search results to a level of specificity at which the user left off during the prior search session.

In some implementations, synthetic search queries generated by context engine 113 may include suggested next queries/prompts for the user. These may be presented to the user so that the user can accept or reject them. For example, one or more of the generated synthetic queries may be presented to the user as a “next step suggestion,” e.g., as a tile or link, e.g., in addition to or instead of being executed automatically.

As an example, suppose the user states in the current query 870, “I'm looking for good cameras to capture my friend's wedding.” One or more of the following suggested next steps might be generated as synthetic queries, e.g., immediately or at a suitable time during the user's current search session: “What is the average price range?”; “Do I need any other accessories?”; “What's the best camera for outdoor weddings?;” and so forth.

In some implementations, context engine 113 may employ one or more “pre-trigger” classifiers 152 (e.g., a machine learning model) to classify current query 870 and/or user state 871 into one or more of a plurality of categories. Non-limiting examples of these categories may include, for instance, (i) “needs creative text generation,” (ii) “needs creative media generation,” (iii) “can benefit from ambient generative summarization,” (iv) “can benefit from SRP summarization,” (v) “would benefit from suggested next step query,” (vi) “needs clarification,” (vii) “do not interfere,” and so forth. In various implementations, these pre-trigger classifications may be preserved through the remainder of the current turn of the user's search session, e.g., to select one or more downstream LLM(s) to utilize.

The synthetic search queries generated by context engine 113 may then be provided to search system(s) 160. Search system(s) 160 may execute one or more searches using one or more of the synthetic search queries to generate one or more SRPs. If there are multiple generated queries, they may be executed in parallel or in series (step-by-step). As noted elsewhere herein, each search result in the SRP may include, for instance, a passage of text describing the underlying digital content that is, for instance, linked to by a hyperlink of the search result. These passages can be extracted verbatim from the underlying digital content, extracted from metadata associated with the underlying digital content, or generated from the digital content, e.g., using a generative summarization generative model (e.g., 872C).

The results (e.g., SRPs, SRDs) generated by search system(s) 160 based on the one or more synthetic queries (and current query 870, in some cases), data indicative of user state 871, and/or current query 870 itself may be provided to LLM selection engine 132, as shown in FIG. 8. LLM selection engine 132 may be configured to classify these data (e.g., current query 870+user state 871+synthetic search queries+SRPs+passages+result/action), e.g., using one or more classifiers 152.

Classifier(s) 152 may be, for instance, policies taking the forms of various types of machine learning models (e.g., feed forward neural networks, transformers, LLMs, etc.) trained to classify these data into one or more of a plurality of enumerated categories. These enumerated categories may be similar (or the same as) those described previously in reference to the pre-trigger classifier, and may include, for instance, (i) “needs creative text generation,” (ii) “needs creative media generation,” (iii) “can benefit from ambient generative summarization,” (iv) “can benefit from SRP summarization,” (v) “would benefit from suggested next step query,” (vi) “needs clarification,” (vii) “do not interfere,” and so forth.

Classifier(s) 152 may be trained using various techniques, including but not limited to reinforcement learning. In some implementations, reinforcement learning in particular allows for ongoing training of classifier(s) 152 over time, based on multitudes of users and search sessions. In some implementations, positive rewards may be generated where the user responds positively to the output and/or stays engaged with the search session. Negative rewards, by contrast, may be awarded to the reinforcement learning policy where the user responds negatively and/or changes direction of search abruptly.

Based on a classification (generated by context engine 113 as a pre-trigger classification or by LLM selection engine 132 as a post-trigger classification), LLM selection engine 132 may selectively trigger LLM response generation engine 136 to apply various generative models 150, including 872A-F, trained to generate different types of content. The multiple candidate generative models 872A-F can include additional and/or alternative models, such as a larger size generative model and a smaller size generative model. The larger size generative model can be more robust and/or more accurate than the smaller size generative model, but requires more computational resources (e.g., memory and/or processor resources) to utilize.

For example, the “needs creative text generation” classification may cause LLM selection engine 132 to select and trigger LLM response generation engine 136 to generate creative textual content (e.g., a poem, short story, etc.) using a creative text LLM 872A. In some cases this creative generation facilitated by creative text LLM 872A may be based primarily on current query 870 and user state 871, although that is not meant to be limiting.

The “needs creative media generation” classification may cause LLM selection engine 132 to select and trigger LLM response generation engine 136 to generate creative media content (e.g., an image, 3D model, animation, audio output, etc.) using creative media generative model(s) 872B. If the user permitted the generative companion (e.g., chat engine 144) access to the user's content, such as personal photos, personal correspondence, personal videos, etc., then that personal content may be available for creative content generation. For example, LLM input engine 134 may provide, e.g., to LLM response generation engine 136, personal content as permitted by the user. LLM response generation engine 136 may apply data indicative of this personal content (e.g., the content itself, embeddings generated therefrom, etc.) as input to creative media generative model(s) 872B. This may cause generation of creative content that incorporates the user's personal content, in addition to or instead of more broadly available content used to train creative media LLM(s) previously. For instance, if the user provides the query, “make me a photo showing me flying over the golden gate bridge,” LLM input engine 134 may access photos depicting the user, e.g., in conjunction with photos depicting the bridge, for use by LLM response generation engine 136 in using creative media content generative model(s) 872B. In such an implementations, creative media content generative model(s) 872B may include, for instance, one or more image diffusion models.

The “can benefit from ambient generative summarization” classification may cause LLM selection engine 132 to select and trigger LLM response generation engine 136 to process digital content (e.g., a SRD) from the SRP that is consumed by user (result/action) using ambient generative LLM(s) 872C. The ambient generative summarization of a particular digital content or domain in which the user is engaged (e.g., access, clicks through, consumes) may be generated, e.g., by LLM response generation engine 136 using ambient generative LLM(s) 872C, based primarily on current query 870 and one or more results and/or actions performed by the user. These results and/or actions may include the user reading and/or interactive with a particular SRD (e.g., a webpage).

In some implementations, the generation of ambient generative content by LLM response generation engine 136 may include grounding, recitation, and/or attribute checking from the SRD itself and/or from data associated with the SRD, such as its metadata. In some implementations, LLM selection engine 132 may trigger ambient generative summarization based on explicit input from the user. For example, if current query 870 could be a question about a current web page being viewed (e.g., in a foreground application such as a web browser), or a request like “summarize this web page for me.”

In some implementations, data from SRP(s) returned by search system(s) may be provided as additional input to ambient generative LLM(s) 872C. For instance, suppose the user is on a particular company's web page and asks, “What competing model is similar to this?” The content of the webpage and content from the SRP (e.g., passages, content from other web page(s) linked to in the SRP) that includes information about the competing model may be included as input for ambient generative LLM(s) 872C.

The “can benefit from SRP summarization” classification may cause LLM selection engine 132 to select and trigger LLM response generation engine 136 to generate an SRP summary using a SRP generative summarization LLM 872D based on a current (and/or prior) SRP. It may be the case that the “can benefit from SRP summarization” classification is most likely to be reached based primarily on current query 870, although this is not required. In some implementations, current query 870 may include constraints and/or parameters to guide SRP summarization by LLM response generation engine 136. For example, current query 870 may include requests such as “Summarize the top 10 results,” “Make a table showing pros and cons from these webpages”, and so forth. Data indicative of these requests may be provided as input to SRP generative LLM(s) 872D, e.g., to cause output to be generated in the prescribed manner. In some implementations, the generative companion (e.g., chat engine 144) can also suggest these types of queries to teach users how to engage with the generative companion.

The SRP summarization performed by LLM response generation engine 136 using SRP generative LLM(s) 872D may be based primarily on a SRP (including passages) that is returned by search system(s) 160 but can also be based on other part(s) of user state 871. Moreover, the SRP summarization performed by LLM response generation engine 136 using SRP generative LLM(s) 872D may include aspects of the linkifying demonstrated in FIG. 3.

SRP summaries may be multimodal. For example, a SRP summary may include text generated from passages or linked-to-document textual content, as well as images retrieved from and/or generated based on images from documents linked to in the SRP. In some implementations, SRP summarization may be influenced by content previously consumed by the user, such that SRP summarization focuses on “new information” that is not already incorporated (e.g., encoded) into user state 871, as demonstrated at blocks 460A-B of FIG. 4, for instance. As one example, if the user recently read a webpage about neural network basics, or already received a SRP summarization that described neural networks at a high level, the next SRP summarization may not repeat the same basic information. Instead, the SRP summarization may retrieve more detailed information about neural networks than was presented to the user previously.

The “can benefit from suggested next step query” classification may cause LLM selection engine 132 to select and trigger LLM response generation engine 136 to generate, based on next step LLM(s) 872E, prompts or queries that are presented to the user to guide the user to a “next step” in the search session. For example, next step LLM(s) 870E may be trained to generate suggestions for next queries that will guide the user's search session. If the user selects a suggested next query, that may function as the “new” current query 870 during the next iteration of the current search session.

In some implementations, suggested next step queries can include suggestions for drilling down the user's search results. For example, if there are over one thousand SRDs returned via one or more SRP(s), but the results can be broadly grouped into three categories, the next step query suggestions may offer the user the choice of narrowing down the SRDs to one of three categorical options. In some implementations, the output generated using next step LLM(s) 872E may include recommended digital content items. For instance, if the user has input multiple queries narrowing down their search to a product that addresses their needs, then a digital content item associated with that product, such as a banner, advertisement, etc., may be presented to the user as a recommendation.

The “needs clarification” classification may cause LLM selection engine 132 to select and trigger LLM response generation engine 136 to generate, based on clarification LLM(s) 872F, NL output such as prompts that seek clarification from the user. For example, if there are ambiguous term(s) in current query 870 that cannot be resolved (e.g., with a threshold level of confidence) using user state 870, one or more prompts may be generated, e.g., using clarification LLM(s) 872F, that seek clarification from the user. As another example, if multiple conflicting interpretations are identified for all or part of current query 870, these interpretations may be presented to the user as choices from which the user can select.

Suppose the user simply states, “New York.” Without more, summarizing an SRP returned in response to such a broad query would not likely be useful to the user. Instead, output generated using clarification LLM(s) 872F may include, for instance, a question such as, “what about New York?” Clarification LLM(s) 872F may additionally or alternatively produce output in the form of questions about the user's general state of mind and/or current activity to enrich user state 871 further, e.g., to increase the likelihood that user state 871 can be used to disambiguate current query 870.

As shown by the dashed arrow in FIG. 8, the “do not interfere” classification may cause LLM selection engine 132 to instruct chat engine 144 to return an SRP that is responsive to current query 870, and nothing more. This may be beneficial for a user who does not wish to engage in a human-to-computer dialog with the generative companion, but instead is simply looking for a particular document or type of document. This may also be beneficial in conserving computing resources, as applying LLM(s) can be computationally expensive and/or energy-intensive. Selectively determining whether to generate LLM output or not, based on one or more objective criteria that seek to select LLM application only when doing so, is likely to decrease computational loads on the cloud-based infrastructure that most likely will be applying LLM(s) to data.

Once LLM response generation engine 136 has caused generation of LLM output(s) (or no LLM output where not warranted), these outputs and/or any other NL output that is responsive to current query 870 may be obtained, generated, and/or rendered by chat engine 144 at a client device of the user. As noted elsewhere, the output provided by chat engine 144 may be textual and/or multimodal. For example, a SRP summary generated by LLM response generation engine 136 using SRP generative LLM(s) 872D may include text that is generated based on individual SRDs and/or passages of the SRP, as well as media content that is retrieved from the individual SRDs, or generated by LLM response generation engine 136 using creative media generative model(s) 872B, for instance.

Processing data (e.g., current query 870, user state 871) using LLM(s) can be costly, both in terms of computing resources and time. In instances in which generation of output based on LLM(s) will create latency (which may be frustrating to the user), LLM output can be provided to a user asynchronously. For example, the immediate chat output provided by chat engine 144 may include NL output such as “We are working on your request and will let you know when it's ready.” When the output is ready sometime later, the user may receive a push notification, email, etc. indicating that the output is ready, and/or including the output itself. In some implementations, the manner in which asynchronous output is delivered to the user may be determined based on context. For instance, if the user is still involved in the same search session, or with another search session that involves the generative companion, the user may receive, e.g., as a pop-up, chat output, etc., the asynchronous output. For example, after providing a response to current query 870, chat engine 144 may provide the asynchronous output, e.g., by prefacing it with a statement such as “By the way, I've come up with a response to the request you issued yesterday afternoon: would you like to hear/see it now?”

The generative companion and/or chat engine 144 may render current output 874 to a user in various ways. In some implementations, chat engine 144 may provide a chat interface in which responses and/or LLM-generated output can be delivered inline as current output 874. If the user interacts with the generative companion using spoken utterances, in some implementations, chat engine 144 may respond in kind using computer-generated speech output as current output 874. In some implementations in which the user wears an augmented reality (AR) or virtual reality (VR) client device (e.g., AR headset, VR headset, smart glasses, etc.), chat engine 144 may provide current output 874 as annotations of other objects and/or elements depicted in the AR/VR display(s).

It is not required that all output generated by all components depicted in FIG. 8 be explicitly or directly rendered as current output 874. In some implementations, intermediate outputs generated by one or more components may be used as inputs for other components without being rendered to a user audibly or visually, causing those other components to generate their own outputs that are that much improved. For example, LLM output generated by LLM response generation engine 136 based on LLM(s) 872A-F may be used, for instance, to automatically update an SRP that is presented to the user. For example, next step or clarification questions or queries generated based on LLMs 872E-F may be used by search system(s) 160 to generate new SRPs that are meant to narrow the user's search automatically.

Other actions may also be performed, in additional to or instead of providing current output 874. For instance, in some implementations, new documents (e.g., websites) may be opened in new windows or tabs. New applications (e.g., map application, email application, etc.) may be opened automatically. For example, if the user says, “how do I get to the restaurant listed as the third result,” a map application might be opened automatically, e.g., by chat engine 144. In some implementations, chat engine 144 or another component may also perform action(s) on those additional applications. These actions could be selected, for instance, by applying data indicative of current query 870 and/or user state 871 as input across one or more domain-specific machine learning models. Output of a domain-specific machine learning model may include probability distribution(s) over an action space within that domain.

As an example, if chat engine 144 opens a map application, it may process current query 870 and/or user state 871 using a map application domain model to generate probability distribution(s) over actions in the map application domain, and may selectively perform one or more of those actions based on the probability distribution(s). Map application actions could be, for instance, presenting a map with search results (e.g., restaurants that satisfy current query and user state) marked, centering the map on the highest ranked search result, generating directions from the user's current location to the highest ranked result, etc.

As shown by the arrow from current output 874 to user model 871, in various implementations, user state 871 may be updated based on current output 874, as well as any accompanying metadata. For example, summarizations (SRD or SRP) and/or creatives generated by LLM response generation engine 136 may be added to user state 871 in their native/raw form, or may be encoded into semantically-rich embeddings, bags of words (e.g., using techniques such as TF-IDF), etc., and incorporated with user state 871. Consequently, these data may influence various information generated by various components of FIG. 8 during the next turn or iteration of the generative companion.

In some implementations, user state 871 can be saved as a “footprint” or “journey” that represents a given search session. In some such implementations, that given search session can be resumed later by the user, distributed to other users so that they can pick up where the first user left off, etc. A user may be able to explicitly resume prior search sessions explicitly in some implementations, e.g., by selecting a graphical element or menu item corresponding to a user state 871 built during a prior search session, or by providing a NL command to resume a prior search. In other implementations, a prior search session may be resumed automatically, e.g., in response to a representation (e.g., a semantically rich embedding) of current query 870 and/or user state 871 being similar a semantically rich embedding used to represent a prior user state of a prior search session. Such similarity may be determined, for instance, using edit distances between terms or phrases preserved in the user states, distances in embedding space (e.g., determined using cosine similarity, dot product, Euclidean distance, etc.).

In some implementations, user state 871 can also be summarized as a whole, e.g., describing/summarizing the user's dialog with the generative companion, output rendered, source documents of the content (e.g., provide links), etc. This feature may be used by a user to, for instance, remind the user of the progress they made during the prior search. It may also inform others of the state of the user's search, e.g., so that others can pick up where the user left off.

In some implementations, media (e.g., documents, webpages, videos, etc.) that is consumed by the user during a search session may be encoded and added to user state 871. Consequently, subsequent output provided by chat engine 144 and/or synthetic search queries generated by context engine 133 may reflect the fact that the user consumed this content previously, similar as to what was demonstrated by blocks 460A-B.

Suppose the user spends a considerable amount of time reading a webpage that provides a tutorial about neural networks. Subsequent synthetic search queries generated by context engine 113 may seek out more detailed, lower-level information than high-level tutorial information, e.g., about specific types of neural networks, applications of neural networks, etc.

In some implementations, the generative companion may be invoked explicitly by the user. The generative companion may be invoked at virtually any time, such as while the user is operating a web browser to search for content, while the user is consuming a SRD, while the user operates another application (e.g., a map application, shopping application, game, etc.), and so forth. The generative companion may be implemented as part of (e.g., as a plug in) of a web browser, operating system, or any other software application, or as its own standalone application (e.g., the front end of the generative companion may be implemented as a standalone application on the client device, while the remainder may be implemented in the cloud). In some implementations, the generative companion may be offered as a selectable element on the front page of a web search engine, e.g., alongside other selectable elements that are selectable to initiate other types of searches, such as image searches, video searches, shopping searches, etc.

Suppose a user inputs a search query into a standard search engine front end website. The user may receive an SRP that includes links (and passages, where applicable) to a number of responsive SRDs. In this context, the user may be able to invoke the generative companion, e.g., akin to invoking a virtual assistant, e.g., by uttering one or more “hot words” (also referred to as “wake words”), or by operating a graphical element that invokes the generative companion. Once invoked, the generative companion (e.g., by way of context engine 113) may establish a search session, e.g., by retrieving various contextual information as described previously, including data indicative of the user's search query (now operating as current query 870 in FIG. 8) and data indicative of the SRP and/or its constituent SRDs, and building (or updating) user state 871. This may allow the generative companion to immediately provide relevant information (if current query 870 and user state 871 cause LLM selection engine 132 to issue one of the aforementioned classifications). Alternatively, the generative companion may now be “primed” to interact with the user in subsequent turns of the search session.

In some implementations, the generative companion may be invoked by a user resuming a prior search session, e.g., from a library of preserved search sessions. As discussed previously, user state 871 and one or more current queries 870 issued during a given search session can be preserved, e.g., so that the user can resume the search later, or so that another user can pick up where the first user left off. In some implementations, a user may access a library of prior searches that the user can select from to resume a prior search. Resuming a prior search may effectively invoke the generative companion.

In some implementations, the library of prior search sessions may be hierarchal. For instance, a prior search session that is broadly associated with planning an entire vacation may be broken up into sub-search sessions, one associated with searching for accommodations, another associated with searching for activities, another associated with searching for restaurants, another associated with searching for transportation, etc. Selectable elements and/or the underlying prior search sessions can be shared across multiple people and/or published, e.g., akin to a live document. Thus, a user can delegate subtasks of a broad search by sharing these sub-search sessions with others. In some implementations, prior search sessions can be suggested automatically in response to current contextual signals. For example, in response to a particular current query 870, chat engine 144 may respond, “I see that you're looking at hotels in Belgrade again. Do you want me to pull up your previous search results?”

In some implementations, the generative companion may be implemented as part of a more general-purpose virtual assistant. For example, the user may use the same means (e.g., hot words, selectable element, hardware button, gesture, etc.) to invoke the generative companion during a search session as the user would to invoke the virtual assistant in other, non-search contexts, e.g., while cooking, driving a vehicle, to operate one or more smart appliances, to control playback of music or other media content, etc. In other implementations, the generative companion may be invoked with hot words that differ from those usable to invoke a general-purpose virtual assistant.

In some implementations, the generative companion may perform, on demand, linkifying operations, examples of which were demonstrated in FIG. 3. For instance, when LLM response generation engine 136 generates, using any of LLM(s) 872C-D, summary of content returned during a search session, the user may ask, “can you cite sources?” In response, the generative companion may perform operations akin to those demonstrated FIG. 3 to return, for instance, a version of the summary annotated with sources.

The various LLMs described herein may be trained in various ways on various types of training data, depending on the intended purpose of each LLM. For example, creative text LLM(s) 872A may be trained based on content such as poetry, creative writing, fictional works (e.g., novels, short stories), correspondence, nonfictional works, etc. Creative media geneative model(s) 872B may be trained on content such as images and accompanying image captions. LLM(s) 150 used by context engine 113 to generate synthetic search queries may be trained, for instance, using search query logs.

In addition, training may be performed in different ways during different stages. For example, an LLM may initially be trained (sometimes referred to as “bootstrapped”) offline, e.g., using human-curated datasets. “Offline” may refer to the LLM not being available yet for use, in some cases. After some amount of training, the LLM may be further tuned using a much larger dataset, such as the example of the LLM(s) used by context engine 113 being trained based on search query logs. A final stage of training (which may be performed on an ongoing basis to continue improving the LLM) may involve generating synthetic data sets of multi-step tasks based on search logs. For example, a sequence of queries issued manually by a user during a time interval may be selected and used as training data to train the LLM to parse multi-step tasks.

Turning now to FIG. 9, a flowchart is depicted that illustrates an example method 900 of implementing a generative companion to enrich a search session. For convenience, the operations of the method 900 are described with reference to a system that performs the operations. This system of the method 900 includes one or more processors, memory, and/or other component(s) of computing device(s) (e.g., client device 110 of FIG. 1, client device 1010 of FIG. 10, and/or computing device 710 of FIGS. 7A and 7B, one or more servers, and/or other computing devices). Moreover, while operations of the method 900 are shown in a particular order, this is not meant to be limiting. One or more operations may be reordered, omitted, and/or added.

At block 952, the system may receive a query (e.g., current query 870 of FIG. 8) associated with a client device operated by the user. Block 952 can include one or more aspects in common with block 252 of method 200 of FIG. 2 and/or of block 352 of method 300 of FIG. 3.

At block 954, the system, e.g., by way of context engine 113, may retrieve contextual information associated with the user and/or the client device. For example, and as depicted in FIG. 8, context engine 113 may retrieve various information from user state 871. In some implementations, the state data (e.g., user state 871) may be stored as an aggregate embedding generated from, for instance, the current query (e.g., 870), contextual information, one or more synthetic queries generated during prior turns, and/or set(s) of SRDs returned during prior turns. In some implementations, the state data may include data extracted from one or more SRDs returned in response to one or more of the synthetic queries and/or data indicative of one or more actions performed by the user subsequent to issuing the query. In some implementations, the data indicative of one or more actions may include data extracted from one or more of the query-responsive search result documents accessed by the user.

As additional examples the contextual information associated with the user or the client device may include: one or more prior queries issued by the user during the search session; data extracted from one or more SRPs returned in response to one or more prior queries issued by the user during the search session; data extracted from prior-query-responsive SRD(s) returned in response to one or more prior queries issued by the user during the search session; position coordinates of the user; and/or information about a schedule of the user. Information about a schedule of the user can include, for instance, data retrieved from an electronic calendar of the user, electronic correspondence of the user, an electronic calendar of another user, or electronic correspondence of another user.

At block 956, the system, e.g., by way of context engine 113, may generate generative model (e.g., LLM) output based on processing, using a generative model such as an LLM (e.g., 150), data indicative of the query (e.g., 870) and the contextual information (e.g., 871).

At block 958, the system, e.g., by way of context engine 113 and/or implied input engine 114, may generate one or more synthetic queries using the LLM output. For example, tokens predicted by the LLM may be organized into one or more sequences, each sequence forming a distinct synthetic query.

At block 960, the system, e.g., by way of search systems 160 and/or SRD selection engine 122, may select a set of search result documents. In various implementations, selecting the set of search result documents may include selecting, for inclusion in the set, a plurality of query-responsive SRDs based on the query-responsive SRDs being responsive to the query (e.g., 870) and the one or more synthetic queries.

At block 962, the system, e.g., by way of LLM selection engine 132, may process state data (e.g., 871), wherein the state data is indicative of the query, contextual information, one or more of the synthetic queries, and the set of search result documents, to identify a classification of the query. Based on the classification of the query, at block 964, the system, e.g., by way of LLM selection engine 132, may select one or more downstream LLMs (e.g., 872A-F).

At block 966, the system, e.g., by way of LLM response generation engine 136, may generate one or more additional LLM outputs based on processing, using the selected one or more downstream LLMs, at least some of the state data. At block 968, the system may cause content such as NL responsive to the query to be rendered at the client device. At shown by the arrow in FIG. 9, in various implementations, the state data, newly updated based on additional data generated and/or output during the current turn of the human-to-computer dialog session between the user and the generative companion, may be passed back to, e.g., context engine 113, and the process 900 may repeat for a next turn of the search session. Put another way, the NL responsive to the most recent query from the user may be included in subsequent contextual information retrieved during one or more subsequent turns of the search session of the user.

Turning now to FIG. 10, a block diagram of an example computing device 1010 that may optionally be utilized to perform one or more aspects of techniques described herein is depicted. In some implementations, one or more of a client device, cloud-based automated assistant component(s), and/or other component(s) may comprise one or more components of the example computing device 1010.

Computing device 1010 typically includes at least one processor 1014 which communicates with a number of peripheral devices via bus subsystem 1012. These peripheral devices may include a storage subsystem 1024, including, for example, a memory subsystem 1025 and a file storage subsystem 1026, user interface output devices 1020, user interface input devices 1022, and a network interface subsystem 1016. The input and output devices allow user interaction with computing device 1010. Network interface subsystem 1016 provides an interface to outside networks and is coupled to corresponding interface devices in other computing devices.

User interface input devices 1022 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 1010 or onto a communication network.

User interface output devices 1020 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 1010 to the user or to another machine or computing device.

Storage subsystem 1024 stores programming and data constructs that provide the functionality of some or all of the modules described herein. For example, the storage subsystem 1024 may include the logic to perform selected aspects of the methods disclosed herein, as well as to implement various components depicted in FIG. 1.

These software modules are generally executed by processor 1014 alone or in combination with other processors. Memory 1025 used in the storage subsystem 1024 can include a number of memories including a main random access memory (RAM) 1030 for storage of instructions and data during program execution and a read only memory (ROM) 1032 in which fixed instructions are stored. A file storage subsystem 1026 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 1026 in the storage subsystem 1024, or in other machines accessible by the processor(s) 1014. Bus subsystem 1012 provides a mechanism for letting the various components and subsystems of computing device 1010 communicate with each other as intended. Although bus subsystem 1012 is shown schematically as a single bus, alternative implementations of the bus subsystem 1012 may use multiple busses.

Computing device 1010 can be of varying types including a workstation, server, computing cluster, blade server, server farm, or any other data processing system or computing device. Due to the ever-changing nature of computers and networks, the description of computing device 1010 depicted in FIG. 10 is intended only as a specific example for purposes of illustrating some implementations. Many other configurations of computing device 1010 are possible having more or fewer components than the computing device depicted in FIG. 10.

In situations in which the systems described herein collect or otherwise monitor personal information about users, or may make use of personal and/or monitored information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be altered before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that the user's particular geographic location cannot be determined. Thus, the user may have control over how information is collected about the user and/or used.

What is claimed is:

1. A method implemented by one or more processors during a search session of a user, the method comprising:
receiving a query associated with a client device operated by the user;
retrieving contextual information associated with the user or the client device;
generating generative model (GM) output based on processing, using an GM, data indicative of the query and the contextual information;
generating one or more synthetic queries using the GM output;
selecting a set of search result documents, selecting the set of search result documents including selecting, for inclusion in the set, a plurality of query-responsive search result documents based on the query-responsive search result documents being responsive to the query and the one or more synthetic queries;
processing state data indicative of the query, contextual information, one or more of the synthetic queries, and the set of search result documents to identify a classification of the query;
based on the classification of the query, selecting one or more downstream GMs;
generating one or more additional GM outputs based on processing, using the selected one or more downstream GMs, at least some of the state data; and
causing content responsive to the query to be rendered at the client device.

2. The method of claim 1, wherein the contextual information associated with the user or the client device includes one or more prior queries issued by the user during the search session.

3. The method of claim 1, wherein the contextual information associated with the user or the client device includes data extracted from one or more search results pages returned in response to one or more prior queries issued by the user during the search session.

4. The method of claim 1, wherein the contextual information associated with the user or the client device includes data extracted from one or more prior-query-responsive search result documents returned in response to one or more prior queries issued by the user during the search session.

5. The method of claim 1, wherein the contextual information associated with the user or the client device includes information about a schedule of the user.

6. The method of claim 5, wherein the information about the schedule of the user is retrieved from one or more of an electronic calendar of the user, electronic correspondence of the user, an electronic calendar of another user, or electronic correspondence of another user.

7. The method of claim 1, wherein the contextual information associated with the user or the client device includes position coordinates of the user.

8. The method of claim 1, wherein the state data comprises an aggregate embedding generated from two or more of the query, contextual information, one or more of the synthetic queries, and the set of search result documents.

9. The method of claim 1, wherein the state data comprises data extracted from one or more search results pages returned in response to one or more of the synthetic queries.

10. The method of claim 1, wherein the state data comprises data indicative of one or more actions performed by the user subsequent to issuing the query.

11. The method of claim 10, wherein the data indicative of one or more actions comprises data extracted from one or more of the query-responsive search result documents accessed by the user.

12. The method of claim 1, wherein one or more of the downstream GMs comprises a creative GM trained to generate creative natural language (NL).

13. The method of claim 1, wherein one or more of the downstream GMs comprises an ambient GM trained to generate a summary of a document accessed by the user subsequent to issuing the query.

14. The method of claim 1, wherein one or more of the downstream GMs comprises a search results GM trained to generate summaries of search results pages.

15. The method of claim 1, wherein the content responsive to the query is included in subsequent contextual information retrieved during one or more subsequent turns of the search session of the user.

16. The method of claim 1, wherein the contextual information comprises prior content responsive to a prior query issued by the user during the search session.

17. A system comprising one or more processors and memory storing instructions that, in response to execution by the one or more processors, cause the one or more processors to:
receive a query associated with a client device operated by the user;
retrieve contextual information associated with the user or the client device;
generate generative model (GM) output based on processing, using an GM, data indicative of the query and the contextual information;
generate one or more synthetic queries using the GM output;
select a set of search result documents, selecting the set of search result documents including selecting, for inclusion in the set, a plurality of query-responsive search result documents based on the query-responsive search result documents being responsive to the query and the one or more synthetic queries;
process state data indicative of the query, contextual information, one or more of the synthetic queries, and the set of search result documents to identify a classification of the query;
based on the classification of the query, select one or more downstream GMs;
generate one or more additional GM outputs based on processing, using the selected one or more downstream GMs, at least some of the state data; and
cause content responsive to the query to be rendered at the client device.

18. The system of claim 17, wherein the contextual information associated with the user or the client device includes one or more prior queries issued by the user during the search session.

19. The system of claim 17, wherein the contextual information associated with the user or the client device includes data extracted from one or more search results pages returned in response to one or more prior queries issued by the user during the search session.

20. At least one non-transitory computer-readable medium comprising instructions that, when executed by one or more processors, cause the one or more processors to:
receive a query associated with a client device operated by the user;
retrieve contextual information associated with the user or the client device;
generate generative model (GM) output based on processing, using an GM, data indicative of the query and the contextual information;
generate one or more synthetic queries using the GM output;
select a set of search result documents, selecting the set of search result documents including selecting, for inclusion in the set, a plurality of query-responsive search result documents based on the query-responsive search result documents being responsive to the query and the one or more synthetic queries;
process state data indicative of the query, contextual information, one or more of the synthetic queries, and the set of search result documents to identify a classification of the query;
based on the classification of the query, select one or more downstream GMs;
generate one or more additional GM outputs based on processing, using the selected one or more downstream GMs, at least some of the state data; and
cause content responsive to the query to be rendered at the client device.
